(19) United States
(12) Patent Application Publication
(10) Pub. No.: US 2025/0360452 A1
(43) Pub. Date: Nov. 27, 2025

(54) GAS TREATMENT METHOD AND APPARATUS

(71) Applicant: HIGHVIEW ENTERPRISES LIMITED, London (GB)

(72) Inventor: Andrew WRIGHT, Lymm, Cheshire (GB)

(21) Appl. No.: 18/872,601

(22) PCT Filed: Jun. 6, 2023
(86) PCT No.: PCT/EP2023/065098

§ 371 Date: Dec. 6, 2024

(30) Foreign Application Priority Data
Jun. 14, 2022 (GB) 2208711.8

(51) Int. Cl. B01D 53/04; B01D 53/047

(52) U.S. Cl. CPC B01D 53/0446; B01D 53/0438; B01D 53/0462; B01D 53/047; B01D 2257/504; B01D 2257/80; B01D 2258/06; B01D 2259/40007; B01D 2259/40028; B01D 2259/40054; B01D 2259/4009

(57) ABSTRACT

Aspects of the present invention relate to a gas treatment apparatus (1) for treating a process gas. The gas treatment apparatus (1) includes a primary treatment unit (2) and a secondary treatment unit (3), the primary and secondary treatment units (2, 3) being configured to treat the process gas. The primary treatment unit (2) includes a primary process gas inlet (10) for receiving the process gas, a first and a second primary adsorber (12, 13) for treating the process gas, and at least one primary process gas outlet for discharging the treated process gas from the first and the second primary adsorbers (12, 13). The secondary treatment unit (3) includes a secondary process gas inlet (30) for receiving the process gas, at least one secondary adsorber (32, 33) for treating the process gas, and at least one secondary process gas outlet (31) for discharging the treated process gas from the at least one secondary adsorber (32, 33) to the primary treatment unit (2). The primary treatment unit (2) is selectively configurable in a first operating mode and a second operating mode. When operating in the first operating mode, the primary process gas inlet (10) is connected to the first primary adsorber (12) to supply the process gas to the first primary adsorber (12) for treatment; and the second primary adsorber (13) is connected to the at least one secondary process gas outlet (31) to receive treated process gas from the secondary treatment unit (3) for regenerating the second primary adsorber (13). When operating in the second operating mode, the primary process gas inlet (10) is connected to the second primary adsorber (13) to supply the process gas to the second primary adsorber (13) for treatment; and the first primary adsorber (12) is connected to the at least one secondary process gas outlet (31) to receive treated process gas from the secondary treatment unit (3) for regenerating the first primary adsorber (12). Aspects of the present invention also relate to a method of controlling a gas treatment apparatus (1) to treat a process gas; and a liquid air energy storage plant.

### TECHNICAL FIELD

The present disclosure relates to a gas treatment method and a gas treatment apparatus. Aspects of the invention relate to a gas treatment apparatus, a method of treating a process gas, a control unit and a liquid air energy storage plant.

### BACKGROUND

Air Purification Units (APUs) are used to extract contaminants and undesirable compounds (henceforth “contaminants”) from an air stream such that a “purified” air stream is produced for a process. These typically operate using an adsorption process whereby the contaminants, which may be gases, water molecules, hydrocarbon particles or any other undesired species, are adsorbed onto the surface of an adsorbent material. The adsorbent material is carefully selected to preferentially adsorb the contaminants that the process designer wishes to remove. There are two types of adsorption: physical and chemical.

APUs are well known in the art of air liquefaction. They are used to produce a clean, dry stream of air to be liquefied-notably avoiding fouling of the process as contaminants freeze and ensuring a pure liquid air product. Typically, the APU of an air liquefier is designed to remove carbon dioxide, moisture and hydrocarbons. An APU typically consists of a vessel containing a particulate bed of adsorbent material through which the process stream flows. Since the adsorbent capacity of an adsorbent material is finite, APUs operate in two principal phases: adsorption and regeneration (otherwise known as desorption). Adsorption is an exothermic process, releasing heat. Desorption requires the addition of heat. Two of the main process parameters affecting adsorption are pressure and temperature, which may be manipulated to alter the equilibrium between the fluid and the adsorbent. In a physical adsorption process, adsorption increases at higher pressure and decreases at higher temperature. In a chemical adsorption process, the relationship with temperature is often more complex. For simplicity, the following description concentrates on physical adsorption, but the principles of the present invention may equally be applied to chemical adsorption processes. Equally, the following description concentrates on the use of APUs for air liquefaction; however, a person skilled in the art will recognise that the principles of the present invention apply to any similar application.

During the adsorption process cycle, pressure and temperature are controlled such that the adsorbent material adsorbs during the adsorption phase and desorbs during the regeneration phase. In what is known in the art as a Pressure Swing Adsorption process, pressure is controlled so that it is high during the adsorption phase and low during the regeneration phase. In what is known in the art as a Temperature Swing Adsorption process, temperature is controlled so that it is low during adsorption and high during regeneration. In a combined cycle, during the adsorption phase, the pressure of the process air stream is high and the temperature is low so that contaminants are adsorbed onto the surface of the adsorbent material. During the regeneration phase, a lower-pressure, higher temperature regeneration gas stream (which may be air or otherwise) is flowed through the bed. As a result, the equilibrium between the gas stream and the adsorbent material is changed such that contaminants are desorbed from the adsorbent material into the gas stream. The regeneration gas stream is then typically exhausted to atmosphere in order to remove the contaminants from the system. The regeneration phase is usually followed by a cooling phase where the adsorbent bed is cooled, using a cooler stream of gas, to a lower temperature before recommencing the adsorption phase. The lower the temperature of the bed, the more efficient the adsorption. Since the adsorption and regeneration phases are both necessary, in order to achieve a continuous flow of purified air to the process, APUs in air separation plants predominantly consist of two vessels, of which one adsorbs while the other is regenerated and then cooled. Once the effective capacity of the adsorbing vessel is reached (saturation), the flow paths are swapped using a system of valves so that the regenerated vessel becomes the adsorbing vessel and the “full” vessel begins regeneration. There is a need to supply a regeneration gas for the duration of the regeneration phases. An inadequate or limited supply of the regeneration gas may require that the process is interrupted until the regeneration phase is complete.

It is an aim of the present invention to address one or more of the disadvantages associated with the prior art.

### SUMMARY OF THE INVENTION

Aspects and embodiments of the invention provide a gas treatment apparatus, a method of treating a process gas, a control unit and a liquid air energy storage plant as claimed in the appended claims.

According to an aspect of the present invention there is provided a gas treatment apparatus for treating a process gas, the gas treatment apparatus comprising a primary treatment unit and a secondary treatment unit, the primary and secondary treatment units being configured to treat the process gas. The primary treatment unit comprises a primary process gas inlet for receiving the process gas, a first and a second primary adsorber for treating the process gas, and at least one primary process gas outlet for discharging the treated process gas from the first and the second primary adsorbers. The secondary treatment unit comprising a secondary process gas inlet for receiving the process gas, at least one secondary adsorber for treating the process gas, and at least one secondary process gas outlet for discharging the treated process gas from the at least one secondary adsorber to the primary treatment unit.

The process gas supplied to the primary treatment unit may be treated by one of the first and second primary adsorbers in the first and second operating modes; and the other one of the first and second primary adsorbers may be regenerated. Regeneration of the first or second primary adsorber may be performed by supplying the treated process gas from the secondary treatment unit.

At least in certain embodiments the primary treatment unit is selectively configurable in a first operating mode and/or a second operating mode. At least in certain embodiments the primary treatment unit may continue to treat the process gas when operating in the first and second operating modes.

The process gas supplied to the primary treatment unit may be treated by the first primary adsorber when the primary treatment unit is configured to operate in the first operating mode. The first primary adsorber may be active in the first operating mode.

The process gas may be treated by the second primary adsorber when the primary treatment unit is configured to operate in the second operating mode. The second primary adsorber may be active in the second operating mode.

When operating in the first operating mode, the primary process gas inlet may be connected to the first primary adsorber to supply the process gas to the first primary adsorber for treatment. The first primary adsorber may be configured to treat the process gas when the primary treatment unit is operating in the first operating mode. The second primary adsorber may be regenerated when the primary treatment unit is operating in the first operating mode. The second primary adsorber may be connected to the at least one secondary process gas outlet to receive treated process gas from the secondary treatment unit for regenerating the second primary adsorber. The second primary adsorber may be regenerated during part or all of the first operating mode. In a variant, the second primary adsorber may be regenerated independently of the operating mode of the primary treatment unit. For example, the second primary adsorber may be regenerated when the first primary adsorber is not operating to treat process gas supplied from the primary process gas inlet.

When operating in the second operating mode, the primary process gas inlet may be connected to the second primary adsorber to supply the process gas to the second primary adsorber for treatment. The second primary adsorber may be configured to treat the process gas when the primary treatment unit is operating in the second operating mode. The first primary adsorber may be regenerated when the primary treatment unit is operating in the second operating mode. The first primary adsorber may be connected to the at least one secondary process gas outlet to receive treated process gas from the secondary treatment unit for regenerating the first primary adsorber. The first primary adsorber may be regenerated during part or all of the second operating mode. In a variant, the first primary adsorber and/or the second primary adsorber may be regenerated independently of the operating mode of the primary treatment unit. For example, the first primary adsorber and/or the second primary adsorber may be regenerated when the primary treatment unit is not operating to treat process gas supplied from the primary process gas inlet.

The primary treatment unit may comprise a plurality of the primary process gas outlets. The primary treatment unit may comprise a first primary process gas outlet for discharging the treated process gas from the first primary adsorber. The primary treatment unit may comprise a second primary process gas outlet for discharging the treated process gas from the second primary adsorber. Alternatively, the one or more primary process gas outlets may be suitable for discharging the treated process gas from both the first and second primary adsorbers.

The secondary treatment unit may comprise a plurality of the secondary process gas outlets. The secondary treatment unit may comprise a first secondary process gas outlet for supplying the treated process gas to the first primary adsorber. The secondary treatment unit may comprise a second secondary process gas outlet for supplying the treated process gas to the second primary adsorber. Alternatively, the one or more secondary process gas outlets may be suitable for supplying the treated process gas to both the first and second primary adsorbers.

At least in certain embodiments, the gas treatment apparatus may purify the process gas. More particularly, the gas treatment apparatus may remove contaminants from the process gas.

In use, the primary treatment unit may be operative to remove contaminants from the process gas. At least in certain embodiments, the primary treatment unit may provide a primary purification unit. At least in certain embodiments, the primary treatment unit may comprise a primary air purification unit.

In use, the secondary treatment unit may be operative to remove contaminants from the process gas. At least in certain embodiments, the secondary treatment unit may provide a secondary purification unit. At least in certain embodiments, the secondary treatment unit may comprise a secondary air purification unit.

At least in certain embodiments, regeneration of the primary treatment unit may be performed by supplying treated process gas received exclusively (i.e., solely) from the secondary treatment unit. This may reduce or remove the need for the primary treatment unit to supply gas for regenerating the first and second primary adsorbers. A primary compressor may be provided for supplying the untreated process gas to the first and second primary adsorbers. The primary compressor may be incorporated into the primary treatment unit or may be separate from the primary treatment unit. Since the regeneration stream for the primary treatment unit may be supplied by the secondary treatment unit, the primary compressor does not need to produce a regeneration stream for the first and second primary adsorbers. Typically, a regeneration stream would be sourced from the feed stream from the primary compressor which would represent a reduction in the available stream for liquefaction in the downstream system. By sourcing a regeneration stream from the secondary treatment unit, the discharge pressure of the primary compressor may be determined in dependence on the required compression of the process gas for feed purposes to the primary treatment unit. This may facilitate optimization of the operation of the primary compressor and, at least in certain embodiments, may allow the primary compressor to operate more efficiently. This may also reduce or avoid the need to throttle the pressure of the process stream which may represent a loss of energy.

The primary treatment unit and the secondary treatment unit may be arranged in parallel to each other.

The gas treatment apparatus may be configured to place the first primary adsorber in fluid communication with the primary process gas inlet and the at least one primary process gas outlet when operating in the first operating mode. In use, untreated (feed) process gas is supplied to the first primary adsorber. The first primary adsorber is configured to treat the process gas by adsorbing one or more or contaminants present therein. The treated process gas may be output from the first primary adsorber to the at least one primary process gas outlet. The gas treatment apparatus may be configured to place the second primary adsorber in fluid communication with the secondary treatment unit when operating in the first operating mode. In use, untreated (feed) process gas is supplied to the secondary treatment unit. The at least one secondary adsorber is configured to treat the process gas by adsorbing one or more or contaminants present therein. The treated process gas is output from the secondary treatment unit to regenerate the primary treatment unit. The treated process gas is supplied to the second primary adsorber to regenerate the second primary adsorber. At least in certain embodiments, the regeneration of the second primary adsorber may be performed at the same time as the first primary adsorber treats the process gas.

The apparatus is configured to place the second primary adsorber in fluid communication with the primary process gas inlet and the at least one primary process gas outlet when operating in the second operating mode. In use, untreated (feed) process gas is supplied to the second primary adsorber. The second primary adsorber is configured to treat the process gas by adsorbing one or more or contaminants present therein. The treated process gas may be output from the second primary adsorber to the at least one primary process gas outlet. The apparatus is configured to place the first primary adsorber in fluid communication with the secondary treatment unit in the second operating mode. In use, untreated (feed) process gas is supplied to the secondary treatment unit. Untreated (feed) process gas is supplied to the secondary treatment unit to adsorb one or more or contaminants. The treated process gas is output from the secondary treatment unit to the primary treatment unit. The treated process gas is supplied to the first primary adsorber to regenerate the first primary adsorber. At least in certain embodiments, the regeneration of the first primary adsorber may be performed at the same time as the second primary adsorber treats the process gas.

When operating in the first operating mode, a portion of the treated process gas from the first primary adsorber may be supplied to re-pressurise the second primary adsorber after regeneration of the second primary adsorber.

When operating in the second operating mode, a portion of the treated process gas from the second primary adsorber is supplied to re-pressurise the first primary adsorber after regeneration of the first primary adsorber.

When operating in the first operating mode, the second primary adsorber may be de-pressurized prior to regeneration of the second primary adsorber.

When operating in the second operating mode, the first primary adsorber may be de-pressurized prior to regeneration of the first primary adsorber.

The gas treatment apparatus may comprise a primary regeneration heater. The primary regeneration heater may be configured to heat the treated process gas from the secondary treatment unit prior to introduction into the primary treatment unit.

The gas treatment apparatus may be selectively configurable to regenerate the secondary treatment unit.

The at least one secondary adsorber may comprise first and second secondary adsorbers for treating the process gas. In use, one of the first and second secondary adsorbers may be operatively selected to treat the process gas; and the other one of the first and second secondary adsorbers may be regenerated. A portion of the treated process gas from the selected one of the first and second secondary adsorbers may be output to regenerate the other one of the first and second secondary adsorbers.

The regeneration of the secondary treatment unit may be performed independently of the operating mode of the primary treatment unit. The at least one secondary adsorber may comprise a first secondary adsorber and a second secondary adsorber. In use, one of the first and second secondary adsorbers may be operatively selected to treat the process gas supplied to the secondary treatment unit. The treated process gas may be output from the secondary treatment unit to the primary treatment unit to regenerate the at least one of the first and second primary adsorbers. The other one of the first and second secondary adsorbers may be regenerated. The regeneration of the first and second secondary adsorbers may be performed independently of the operation of the primary treatment unit. For example, the first and second secondary adsorbers may cycle through one or more processing (feed) operations and one or more regeneration operations independently of the operating modes of the primary treatment unit.

The regeneration of the secondary treatment unit may be performed when the primary treatment unit is online (i.e., while process gas is supplied to the primary treatment unit for treatment), or when the primary treatment unit is offline (i.e., while process gas is not supplied to the primary treatment unit for treatment).

Alternatively, the regeneration of the secondary treatment unit may be performed in dependence on of the operation of the primary treatment unit. The gas treatment apparatus may be configured to regenerate the secondary treatment unit while the primary treatment apparatus is operating in the first operating mode or the second operating mode.

The gas treatment apparatus may comprise a secondary regeneration heater. The secondary regeneration heater may be configured to heat the treated process gas for regenerating the other one of the first and second secondary adsorbers.

The gas treatment apparatus may comprise a primary compressor for compressing the process gas supplied to the primary process gas inlet of the primary treatment unit. Alternatively, or in addition, the gas treatment apparatus may comprise a secondary compressor for compressing the process gas supplied to the secondary process gas inlet of the secondary treatment unit.

The gas treatment apparatus may comprise a primary outlet valve system. The primary outlet valve system may comprise at least one outlet valve for controlling the supply of the treated process gas from the primary treatment unit. The primary outlet valve system may be configured selectively to connect the first primary adsorber and/or the second primary adsorber to the at least one primary process gas outlet.

The primary outlet valve system may be configured selectively to connect the secondary treatment unit to one of the first and second primary adsorbers to perform regeneration. The primary outlet valve system may be configured to connect the first primary adsorber to the at least one primary process gas outlet when operating in the first operating mode. The primary outlet valve system may be configured to connect the second primary adsorber to the at least one primary process gas outlet when operating in the second operating mode.

The primary outlet valve system may be configured to connect the secondary treatment unit to the second primary adsorber when operating in the first operating mode. The primary outlet valve system may be configured to connect the secondary treatment unit to the first primary adsorber when operating in the second operating mode.

The gas treatment apparatus may comprise a secondary outlet valve system. The secondary outlet valve system may comprise at least one outlet valve for controlling the supply of the treated process gas from the secondary treatment unit. The secondary outlet valve system may be configured selectively to connect the at least one secondary adsorber to the at least one secondary process gas outlet.

The gas treatment apparatus may comprise a primary inlet valve system. The primary inlet valve system may comprise at least one inlet valve for controlling the supply of the untreated process gas to the primary treatment unit. The primary inlet valve system may be configured selectively to connect the primary process gas inlet to the first primary adsorber and/or the second primary adsorber.

The primary inlet valve system may be configured selectively to connect the primary process gas inlet to one of the first and second primary adsorbers. The primary inlet valve system may be configured selectively to vent process gas from one of the first and second primary adsorbers for depressurising said first and second primary adsorber.

The primary inlet valve system may be configured to connect the first primary adsorber to the primary process gas inlet when operating in the first operating mode. The primary outlet valve system may be configured to vent the second primary adsorber when operating in the first operating mode.

The primary inlet valve system may be configured to connect the second primary adsorber to the primary process gas inlet when operating in the second operating mode. The primary outlet valve system may be configured to vent the first primary adsorber when operating in the second operating mode.

The gas treatment apparatus may comprise a secondary inlet valve system. The secondary inlet valve system may comprise at least one inlet valve for controlling the supply of the untreated process gas to the secondary treatment unit. The secondary inlet valve system may be configured selectively to connect the secondary process gas inlet to the first secondary adsorber and/or the second secondary adsorber.

The secondary inlet valve system may be configured selectively to connect the secondary process gas inlet to one of the first and second secondary adsorbers. The secondary inlet valve system may be configured selectively to vent process gas from one of the first and second secondary adsorbers. The process gas may be vented to depressurise said first and second primary adsorber.

The primary treatment unit and the secondary treatment unit may be configured to remove carbon dioxide (CO2) and water (H20) from the process gas.

The process gas supplied to the gas treatment apparatus is typically an untreated (feed) process gas. The process gas may be air. The air may, for example, be drawn from atmosphere.

The primary treatment unit may provide a primary air treatment unit. At least in certain embodiments, the primary air treatment unit may be a primary air purification unit (PAPU).

The secondary treatment unit may provide a secondary air treatment unit. At least in certain embodiments, the secondary air treatment unit may be a secondary air purification unit (SAPU).

According to a further aspect of the present invention there is provided a method of controlling a gas treatment apparatus to treat a process gas, the gas treatment apparatus comprising:
a primary treatment unit comprising a primary process gas inlet for receiving the process gas, a first and a second primary adsorber for treating the process gas, and at least one primary process gas outlet for discharging the treated process gas from the first and the second primary adsorbers; and
a secondary treatment unit comprising a secondary process gas inlet for receiving the process gas, at least one secondary adsorber for treating the process gas, and at least one secondary process gas outlet for discharging the treated process gas from the at least one secondary adsorber to the primary treatment unit.

At least in certain embodiments, the method may comprises selectively operating the primary treatment unit in a first operating mode and a second operating mode.

When operating in the first operating mode, the primary process gas inlet may be connected to the first primary adsorber to supply the untreated process gas to the first primary adsorber for treatment. The second primary adsorber may be connected to the at least one secondary process gas outlet to receive treated process gas from the secondary treatment unit for regenerating the second primary adsorber.

When operating in the second operating mode, the primary process gas inlet may be connected to the second primary adsorber to supply the process gas to the second primary adsorber for treatment. The first primary adsorber may be connected to the at least one secondary process gas outlet to receive treated process gas from the secondary treatment unit for regenerating the first primary adsorber.

The at least one secondary adsorber may comprise a first secondary adsorber and a second secondary adsorber. In use, one of the first and second secondary adsorbers may be operatively selected to treat the process gas supplied to the secondary treatment unit. The treated process gas may be output from the secondary treatment unit to the primary treatment unit to regenerate the at least one of the first and second primary adsorbers. The other one of the first and second secondary adsorbers may be regenerated. The regeneration of the first and second secondary adsorbers may be performed independently of the operation of the primary treatment unit. For example, the first and second secondary adsorbers may cycle through one or more processing (feed) operations and one or more regeneration operations independently of the operating modes of the primary treatment unit.

According to an aspect of the present invention there is provided a gas treatment apparatus for treating a process gas, the gas treatment apparatus comprising a primary treatment unit and a secondary treatment unit, the primary and secondary treatment units being configured to treat the process gas, wherein:
the primary treatment unit comprises a primary process gas inlet for receiving the process gas, a first and a second primary adsorber for treating the process gas, and at least one primary process gas outlet for discharging the treated process gas from the first and the second primary adsorbers; and
the secondary treatment unit comprises a secondary process gas inlet for receiving the process gas, at least one secondary adsorber for treating the process gas, and at least one secondary process gas outlet for discharging the treated process gas from the at least one secondary adsorber to the primary treatment unit;
wherein, in use, the primary process gas inlet is connected to the first primary adsorber to supply the process gas to the first primary adsorber for treatment in a first operating mode; and the primary process gas inlet is connected to the second primary adsorber to supply the process gas to the second primary adsorber for treatment in a second operating mode; and
wherein, in use, the secondary treatment unit is selectively connected to at least one of the first and the second primary adsorbers to supply treated process gas to regenerate the at least one of the first and the second primary adsorbers.

The gas treatment apparatus may be configured selectively to operate the primary treatment unit in either the first operating mode or the second operating mode. Depending on the selected operating mode, either the first or the second primary adsorber may be operative to treat the process gas supplied from the primary process gas inlet.

The secondary treatment unit may be selectively connected to the at least one of the first and the second primary adsorbers. The at least one of the first and the second primary adsorbers may be regenerated by supplying the treated process gas from the secondary treatment unit.

The gas treatment apparatus may be selectively configurable to regenerate the secondary treatment unit. The regeneration of the secondary treatment unit may be performed independently of the operating mode of the primary treatment unit.

The at least one secondary adsorber may comprise a first secondary adsorber and a second secondary adsorber. In use, one of the first and second secondary adsorbers is operatively selected to treat the process gas supplied to the secondary treatment unit. The treated process gas may be output from the secondary treatment unit to the primary treatment unit to regenerate the at least one of the first and second primary adsorbers. The other one of the first and second secondary adsorbers may be regenerated. The regeneration of the first and second secondary adsorbers may be performed independently of the operation of the primary treatment unit. For example, the first and second secondary adsorbers may cycle through one or more processing (feed) operations and one or more regeneration operations independently of the operating modes of the primary treatment unit.

According to a further aspect of the present invention there is provided a gas treatment apparatus for treating a process gas, the gas treatment apparatus comprising a primary treatment unit and a secondary treatment unit, the primary and secondary treatment units being configured to treat the process gas, wherein:
the primary treatment unit comprises a primary process gas inlet for receiving the process gas, a first and a second primary adsorber for treating the process gas, and at least one primary process gas outlet for discharging the treated process gas from the first and the second primary adsorbers;
the secondary treatment unit comprises a secondary process gas inlet for receiving the process gas, at least one secondary adsorber for treating the process gas, and at least one secondary process gas outlet for discharging the treated process gas from the at least one secondary adsorber to the primary treatment unit.

At least in certain embodiments, the primary treatment unit may be selectively configurable in a first operating mode and a second operating mode.

When operating in the first operating mode, the first primary adsorber may be placed in fluid communication with the primary process gas inlet and the at least one primary process gas outlet. The second primary adsorber may be placed in fluid communication with the secondary treatment unit.

When operating in the second operating mode, the second primary adsorber may be placed in fluid communication with the primary process gas inlet and the at least one primary process gas outlet. The first primary adsorber may be placed in fluid communication with the secondary treatment unit.

According to an aspect of the present invention there is provided a method of controlling a gas treatment apparatus to treat a process gas, the gas treatment apparatus comprising:
a primary treatment unit comprising a primary process gas inlet for receiving the process gas, a first and a second primary adsorber for treating the process gas, and at least one primary process gas outlet for discharging the treated process gas from the first and the second primary adsorbers; and
a secondary treatment unit comprising a secondary process gas inlet for receiving the process gas, at least one secondary adsorber for treating the process gas, and at least one secondary process gas outlet for discharging the treated process gas from the at least one secondary adsorber to the primary treatment unit;
wherein the method comprises:
   connecting the primary process gas inlet to the first primary adsorber to supply the untreated process gas to the first primary adsorber for treatment in a first operating mode;
   connecting the primary process gas inlet to the second primary adsorber to supply the process gas to the second primary adsorber for treatment in a second operating mode; and
   connecting the secondary treatment unit to at least one of the first and the second primary adsorbers to supply treated process gas to regenerate the at least one of the first and the second primary adsorbers.

The method may comprise selectively operating the primary treatment unit in either the first operating mode or the second operating mode. Depending on the selected operating mode, either the first or the second primary adsorber may be operative to treat the process gas supplied from the primary process gas inlet.

The method may comprise selectively connecting the secondary treatment unit to the at least one of the first and the second primary adsorbers. The at least one of the first and the second primary adsorbers may be regenerated by supplying the treated process gas from the secondary treatment unit.

The at least one secondary adsorber may comprise a first secondary adsorber and a second secondary adsorber. The method may comprise selecting one of the first and second secondary adsorbers to treat the process gas supplied to the secondary treatment unit. The treated process gas may be output from the secondary treatment unit to the primary treatment unit to regenerate the at least one of the first and second primary adsorbers. The other one of the first and second secondary adsorbers may be regenerated. The regeneration of the first and second secondary adsorbers may be performed independently of the operation of the primary treatment unit. For example, the first and second secondary adsorbers may cycle through one or more processing (feed) operations and one or more regeneration operations independently of the operating modes of the primary treatment unit.

According to a further aspect of the present invention there is provided an electronic control unit configured to control a gas treatment apparatus to perform the method(s) described herein. The electronic control unit comprises at least one electronic processor and at least one memory device. A set of computational instructions is stored on the memory device. When executed by the at least one electronic processor, the computational instructions cause the at least one electronic processor to perform the method(s) described herein.

According to a further aspect of the present invention there is provided a liquid air energy storage plant comprising a gas treatment apparatus as described herein.

Unless indicated to the contrary (implicitly, explicitly or due to an incompatibility), references herein to components being connected to each other or in fluid communication with each other is to be understood as referring to the components being fluidically connected to each other such that, in use, fluid is conveyed between the components. The fluid may, for example, comprise one or more of the following: the untreated (feed) process gas, the treated process gas, and the regeneration gas. By way of example, a reference to the process gas inlet being connected to or in fluid communication with an adsorber (in the primary or secondary treatment unit) refers to the process gas inlet being fluidically connected to the adsorber to enable the conveyance of the process gas to the adsorber. By way of further example, a reference to an adsorber (in the primary or secondary treatment unit) being connected to or in fluid communication with a process gas outlet refers to the adsorber being fluidically connected to the process gas outlet to enable conveyance of the treated process gas to the process gas outlet. These examples are non-limiting and other examples of components being fluidically connected to each other are within the scope of the present application.

The valves described herein may be operable selectively to establish or inhibit a fluidic connection. Alternatively, or in addition, the valves may provide variable or proportional control of the fluid. The valves may, for example, comprise a variable valve or a proportional valve to control the supply of fluid within the gas treatment apparatus.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a gas treatment apparatus having a primary treatment unit and a secondary treatment unit in accordance with an embodiment of the present invention;

FIG. 2 shows a schematic representation of a control unit for controlling the gas treatment apparatus shown in FIG. 1;

FIG. 3A shows a schematic representation of a first or second primary adsorber of the gas treatment apparatus shown in FIG. 1;

FIG. 3B shows a schematic representation of an alternative configuration of the first or second primary adsorber of the gas treatment apparatus shown in FIG. 1;

FIG. 4 shows a schematic representation of a primary chiller provided for cooling air supplied from a primary compressor;

FIG. 5 shows the primary treatment unit operating in a second operating mode in which the second primary adsorber bed treats the untreated (feed) process gas supplied from a primary process gas inlet;

FIG. 6 shows the primary treatment unit operating in a first operating mode in which the first primary adsorber bed treats the untreated (feed) process gas supplied from a primary process gas inlet while the second primary adsorber is de-pressurized;

FIG. 7 shows the primary treatment unit operating in the first operating mode while the second primary adsorber is regenerated;

FIG. 8 shows the primary treatment unit operating in the first operating mode while the second primary adsorber is re-pressurized;

FIG. 9 shows a first plot of the simulated temperature within one of the first and second primary adsorber beds during regeneration;

FIG. 10 shows a schematic representation of a second secondary adsorber of the secondary treatment unit operative to treat process gas for regenerating the primary treatment unit;

FIG. 11 shows a schematic representation of the second secondary adsorber supplying processed gas to regenerate the first secondary adsorber of the secondary treatment unit;

FIG. 12 shows a schematic representation of the first secondary adsorber being re-pressurized by supplying treated process gas from the second secondary adsorber;

FIG. 13 shows a schematic representation of the first secondary adsorber of the secondary treatment unit operative to treat process gas for regenerating the primary treatment unit;

FIG. 14 shows a schematic representation of the first secondary adsorber supplying processed gas to regenerate the second secondary adsorber of the secondary treatment unit; and

FIG. 15 shows a schematic representation of the second secondary adsorber being re-pressurized by supplying treated process gas from the first secondary adsorber.

### DETAILED DESCRIPTION

All values stated herein for physical quantities such as pressure, temperature, mass flow, rate, etc. are exemplary and intended to aid understanding of the invention. A person skilled in the art will understand that a wide range of values is possible for these physical quantities depending on the particular scale or implementation of the present invention and requirements of the user, and that unless stated otherwise, the present invention is not limited to these stated values.

A gas treatment apparatus 1 for treating a process gas in accordance with an embodiment of the present invention is described herein with reference to the accompanying Figures. The gas treatment apparatus 1 is configured to be used in a liquid air energy storage plant.

As described herein, the gas treatment apparatus 1 is configured to treat the process gas to remove contaminants, typically by adsorbing the contaminants. In the present embodiment, the process gas is ambient air which is compressed and supplied to the gas treatment apparatus 1 at a pressure greater than atmospheric pressure. The gas treatment apparatus 1 is configured to remove carbon dioxide (CO2) and water (H20) from the air. The process gas supplied to the gas treatment apparatus 1 is referred to herein as an untreated (feed) process gas. The process gas discharged from the gas treatment apparatus 1 is referred to herein as a treated process gas. The untreated (feed) process gas may be referred to as a wet process gas; and the treated process gas may be referred to as a dry process gas. It will be understood that the process gas may undergo additional treatment processes before and/or after supply to the gas treatment apparatus 1. It will be understood that the gas treatment apparatus 1 and the processing methods described herein could be used to treat process gases other than air.

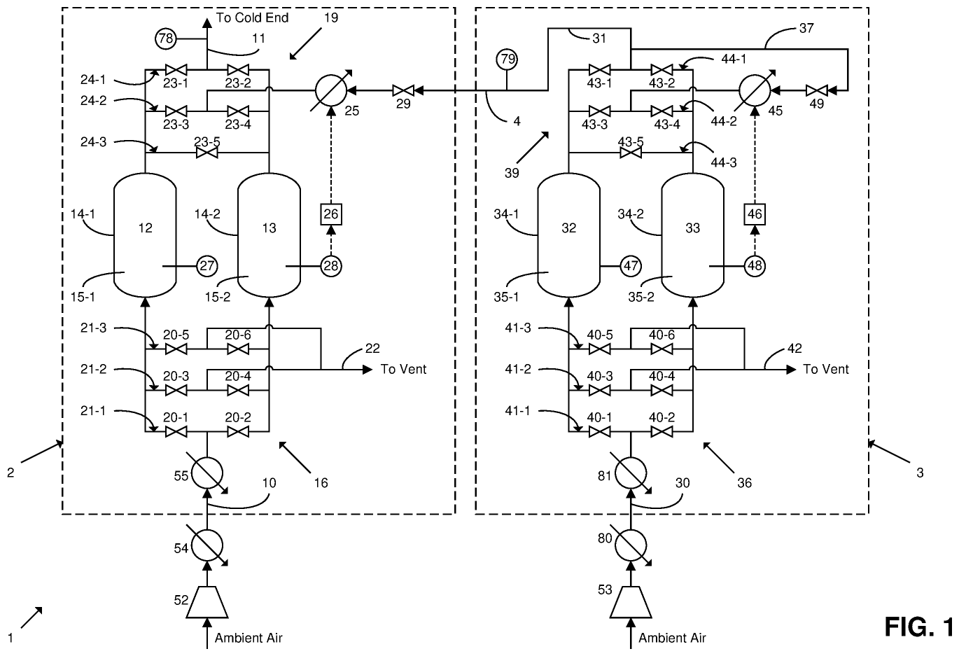

As shown in FIG. 1, the gas treatment apparatus 1 comprises a primary treatment unit 2 and a secondary treatment unit 3. The primary treatment unit 2 is configured to operate as a primary air purification unit (PAPU); and the secondary air treatment unit 3 is configured to operate as a secondary air purification unit (SAPU). The primary treatment unit 2 is configured to receive the untreated (feed) process gas. The primary treatment unit 2 functions as a primary air purification unit; and the secondary treatment unit 3 functions as a secondary air purification unit. The primary treatment unit 2 removes carbon dioxide (CO2) and water (H20) from the untreated (feed) process gas and discharges the treated process gas. The secondary treatment unit 3 is configured to supply a regeneration gas for regenerating the primary treatment unit 2. The primary treatment unit 2 is configured to receive the untreated (feed) process gas. The untreated (feed) gas is processed by the secondary treatment unit 3 to remove contaminants. In the present embodiment, the regeneration gas is air that has been treated to remove carbon dioxide (CO2) and water (H20). In the present embodiment, the primary treatment unit 2 and the secondary treatment unit 3 are both configured to treat the same process gas. The primary treatment unit 2 and the secondary treatment unit 3 may be configured to receive the process gas from a common source, for example from the same compressor. In the present embodiment, the primary treatment unit 2 and the secondary treatment unit 3 are configured to receive the untreated (feed) process gas from separate sources. This enables independent control of the supply of the untreated (feed) process gas to the primary treatment unit 2 and the secondary treatment unit 3, for example to enable the untreated (feed) process gas to be supplied at different pressures.

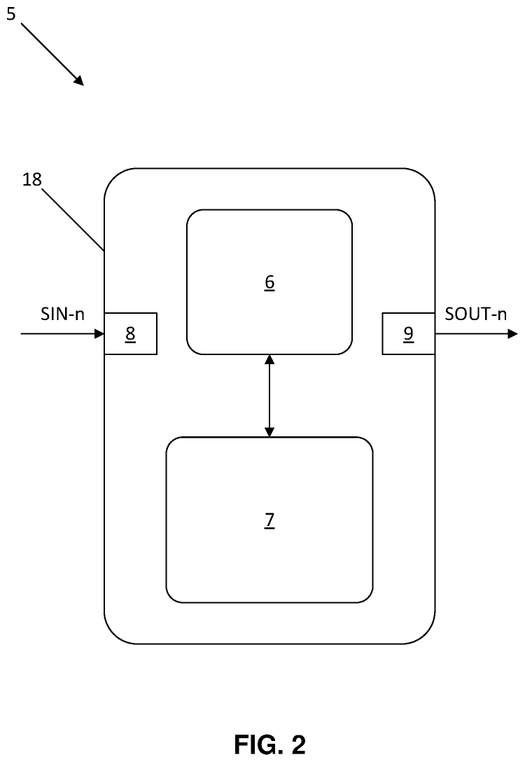

An electronic control unit 5 is provided for controlling operation of the gas treatment apparatus 1. As described herein, the primary treatment unit 2 of the gas treatment apparatus 1 is selectively operable in first and second operating modes. The electronic control unit 5 selectively configures the primary treatment unit 2 to operate in the first and second operating modes. As shown in FIG. 2, the electronic control unit 5 comprises at least one electronic processor 6 and a system memory 7. The at least one electronic processor 6 has at least one input 8 and at least one output 9. The at least one electronic processor 6 is configured to output control signals SOUT-n to control operation of the gas treatment apparatus 1. The control unit 5 may be a dedicated controller or may be a general-purpose computational device executing an application to control operation of the gas treatment apparatus 1. A set of computational instructions is stored on the system memory 7. When executed by the at least one electronic processor 6, the computational instructions cause the at least one electronic processor 6 to implement the method(s) described herein.

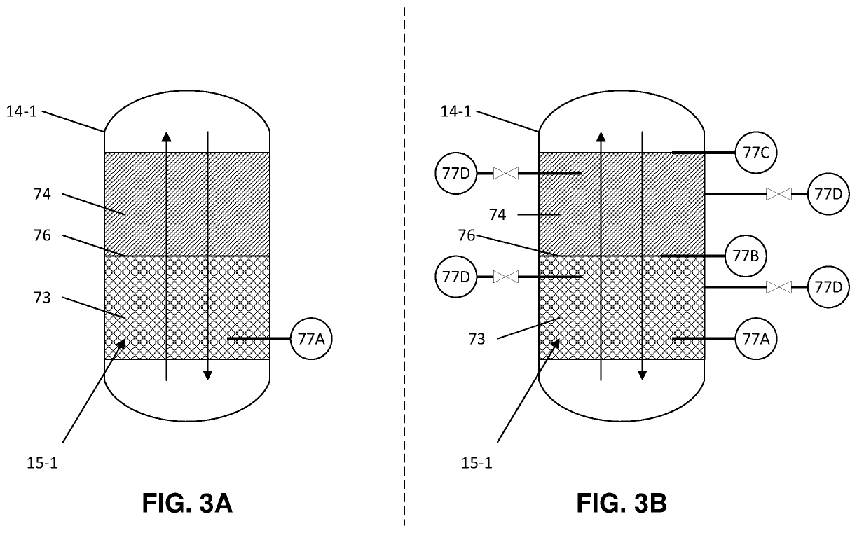

A regeneration gas supply conduit 4 is provided to supply the regeneration gas from the secondary treatment unit 3 to the primary treatment unit 2. The primary treatment unit 2 comprises a primary process gas inlet 10 for receiving the untreated (feed) process gas, at least one primary process gas outlet 11 for discharging the treated process gas, first primary adsorber 12 and a second primary adsorber 13. The first and second primary adsorbers 12, 13 are configured to treat the process gas. The first and second primary adsorbers 12, 13 are arranged in parallel to each other. The first primary adsorber 12 comprises a first primary adsorber vessel 14-1 containing a first primary adsorber bed 15-1. The second primary adsorber 13 comprises a second primary adsorber vessel 14-2 containing a second primary adsorber bed 15-2. In the present embodiment, the first and second primary adsorbers 12, 13 have like configurations. The composition of the first and second primary adsorbers 12, 13 is described in more detail herein with reference to FIGS. 3A and 3B.

As shown in FIG. 1, the primary treatment unit 2 comprises a primary inlet valve system 16 configured selectively to connect the primary process gas inlet 10 to the first and second primary adsorbers 12, 13; and a primary outlet valve system 19 configured selectively to connect the first and second primary adsorbers 12, 13 to the primary process gas outlet 11. In the first operating mode, the primary inlet valve system 16 is configured to connect the primary process gas inlet 10 to the first primary adsorber 12; and to connect the first primary adsorber 12 to the primary process gas outlet 11. In the second operating mode, the primary inlet valve system 16 is configured to connect the primary process gas inlet 10 to the second primary adsorber 13; and to connect the second primary adsorber 13 to the primary process gas outlet 11. The primary inlet valve system 16 comprises a plurality of primary inlet control valves 20-n; and the primary outlet valve system 19 comprises a plurality of primary outlet control valves 23-n.

The primary inlet control valves 20-n are configured to control the supply of the untreated (feed) process gas from the primary process gas inlet 10 to the first and second primary adsorbers 12, 13. Each of the primary inlet control valves 20-n is controllable independently by the control unit 5. The primary inlet control valves 20-n each comprise an actuator, such as a solenoid, which is operable in dependence on a valve control signal. The primary inlet control valves 20-n are two-way valves in the present embodiment, but other types of valve may be used. For example, the primary inlet control valves 20-n may be three-way valves. In the present embodiment, the primary inlet valve system 16 comprises an array of six (6) primary inlet control valves 20-n arranged in pairs in first, second and third inlet branches 21-1, 21-2, 21-3. The primary inlet valve system 16 may comprise any other arrangement of primary inlet control valves 20-n configured to control the supply of the untreated (feed) process gas from the primary process gas inlet 10 to the first and/or second primary adsorbers 12, 13. The primary process gas inlet 10 is connected to the first inlet branch 21-1 between the first and second primary inlet control valves 20-1, 20-2. The first and second primary inlet control valves 20-1, 20-2 are selectively opened and closed to place the primary process gas inlet 10 in fluid communication with one (or both) of the first and second primary adsorbers 12, 13. A primary process gas vent 22 is connected to the second inlet branch 21-2 between the third and fourth primary inlet control valves 20-3, 20-4. The primary process gas vent 22 is also connected to the third inlet branch 21-3 between the fifth and sixth primary inlet control valves 20-5, 20-6. The first and second primary adsorbers 12, 13 can be controllably vented through the primary process gas vent 22. The primary inlet valve system 16 may comprise any other arrangement of primary inlet control valves 20-n configured to controllably vent the first and second primary adsorbers 12, 13 through the primary process gas vent 22. Different configurations of the primary inlet control valves 20-n are contemplated. For example, the fifth and sixth primary inlet control valves 20-5, 20-6 could be omitted. The third and fourth primary inlet control valves 20-3, 20-4 could be configured to depressurise the first and second primary adsorbers 12, 13.

The primary inlet control valves 20-n each have a valve flow coefficient (Cv) representing a flow capacity at fully open operating conditions relative to the pressure drop across the valve. In the present embodiment, the primary inlet control valves 20-n have different valve flow coefficients (Cv). The primary inlet control valves 20-n can be configured to implement different flow capacities for different operating processes. In the present embodiment, the valve flow coefficient (Cv) of the third and fourth primary inlet control valves 20-3, 20-4 is smaller than the valve flow coefficient (Cv) of the fifth and sixth primary inlet control valves 20-5, 20-6. As described herein, the third and fourth primary inlet control valves 20-3, 20-4 are opened to depressurise the first and second primary adsorber vessels, 14-1, 14-2, respectively; and the fifth and sixth primary inlet control valves 20-5, 20-6 are opened to purge (regenerate) the first and second primary adsorber beds 15-1, 15-2, respectively. The smaller valve flow coefficient (Cv) of the third and fourth primary inlet control valves 20-3, 20-4 maintains a low gas flow rate for depressurisation. This may help to avoid a high gas flow rate which could result in a large downwards force on the first and second primary adsorbent bed 15-1, 15-2), potentially causing damage to a support grid for supporting the adsorbent beds 15-1, 15-2. The first and second primary adsorbent beds 15-1, 15-2 are preferably close to atmospheric pressure before initiating the regeneration. Otherwise, opening the purge (regeneration) step valves can result in a very large temporary gas flow due to increased gas flow.

Alternatively, one or more of the primary inlet control valves 20-n may comprise a variable control valve. The third and fourth primary inlet control valves 20-3, 20-4 may each comprise a variable flow control valve operable to modulate or adjust the flow capability. The third and fourth primary inlet control valves 20-3, 20-4 may be configured to provide a first flow capability for depressurisation; and to provide a second flow capability for purge (regeneration). The first flow capability may be less than the second flow capability. Alternatively, or in addition, the third and fourth primary inlet control valves 20-3, 20-4 may be pulsed open and closed (pulse width modulation) to modulate the flow capability. The fifth and sixth primary inlet control valves 20-5, 20-6 may optionally be omitted.

The primary outlet control valves 23-n are configured to control the supply of the treated process gas from the first and/or second primary adsorbers 12, 13 to the other primary adsorber and/or to the primary process gas outlet 11. Each of the primary outlet control valves 23-n is controllable independently by the control unit 5. The primary outlet control valves 23-n each comprise an actuator, such as a solenoid, which is operable in dependence on a valve control signal. The primary outlet control valves 23-n are two-way valves in the present embodiment, but other types of valve may be used. For example, the primary outlet control valves 23-n may be three-way valves. In the present embodiment, the primary outlet valve system 19 comprises an array of five (5) primary outlet control valves 23-n arranged in first, second and third outlet branches 24-1, 24-2, 24-3. The primary outlet valve system 19 may comprise any other arrangement of primary outlet control valves 23-n configured to control the supply of the treated process gas from the first and/or second primary adsorbers 12, 13 to the other primary adsorber and/or to the primary process gas outlet 11. The primary process gas outlet 11 is connected to the first outlet branch 24-1 between the first and second primary outlet control valves 23-1, 23-2. The first and second primary outlet control valves 23-1, 23-2 are opened and closed to place one (or both) of the first and second primary adsorbers 12, 13 in fluid communication with the primary process gas outlet 11. The regeneration gas supply conduit 4 is connected to the second outlet branch 24-2 between the third and fourth primary outlet control valves 23-3, 23-4. The third and fourth primary outlet control valves 23-3, 23-4 are selectively opened and closed to place the regeneration gas supply conduit 4 in fluid communication with one (or both) of the first and second primary adsorbers 12, 13. The third and fourth primary outlet control valves 23-3, 23-4 can both be closed to inhibit the supply of the treated process gas from the regeneration gas supply conduit 4 to the first and second primary adsorbers 12, 13. As described herein, the third and fourth primary outlet control valves 23-3, 23-4 are actuated to control regeneration of the first and second primary adsorbers 12, 13. The third outlet branch 24-3 forms a re-pressurisation conduit for selectively re-pressurising the first and second primary adsorbers 12, 13. The fifth primary outlet control valve 23-5 is provided in the third outlet branch 24-3 selectively to establish fluid communication between the first and second primary adsorbers 12, 13. The fifth primary outlet control valve 23-5 is operated to control re-pressurisation of one of the first and second primary adsorbers 12, 13 from the other one of the first and second primary adsorbers 12, 13. The primary outlet valve system 19 may also comprise any other arrangement of primary outlet control valves 23-n configured to place the regeneration gas supply conduit 4 in fluid communication with one (or both) of the first and second primary adsorbers 12, 13, and to establish fluid communication between the first and second primary adsorbers 12, 13.

A primary regeneration heater 25 is provided in the regeneration gas supply conduit 4 to heat the regeneration gas supplied to the primary treatment unit 2. In the present embodiment, the primary regeneration heater 25 is provided to heat the regeneration gas supplied from the secondary treatment unit 3. A first heater controller 26 is provided for controlling operation of the primary regeneration heater 25. The first heater controller 26 comprises at least one electronic processor having at least one electrical input for receiving first and second primary temperature signals from respective first and second primary temperature sensors 27, 28. The first heat controller 26 may be a separate controller or may be incorporated into the control unit 5. The first primary temperature sensor 27 is configured to measure a first operating temperature T1 of the first primary adsorber 12; and the second primary temperature sensor 28 is configured to measure a second operating temperature T2 of the second primary adsorber 13. A primary regeneration control valve 29 is provided in the regeneration gas supply conduit 4 to control the supply of the treated process gas from the secondary treatment unit 3. The primary regeneration control valve 29 is a two-way valve which can be selectively opened and closed. The primary regeneration control valve 29 is a pneumatic valve in the present embodiment.

The secondary treatment unit 3 comprises a secondary process gas inlet 30 for receiving the untreated (feed) process gas, at least one secondary process gas outlet 31 for discharging the treated process gas, a first secondary adsorber 32 and a second secondary adsorber 33. The first and second secondary adsorbers 32, 33 are configured to treat the process gas. As shown in FIG. 1, the first and second secondary adsorbers 32, 33 are arranged in parallel. The first secondary adsorber 32 comprises a first secondary adsorber vessel 34-1 containing a first adsorber bed 35-1. The second secondary adsorber 33 comprises a second secondary adsorber vessel 34-2 containing a second adsorber bed 35-2. In the present embodiment, the first and second secondary adsorbers 32, 33 have like configurations. The first and second secondary adsorbers 32, 33 have generally the same configuration as the first and second primary adsorbers 12, 13 described herein. Optionally, the volume of the first and second secondary adsorbers 32, 33 may be smaller than the volume of the first and second primary adsorbers 12, 13.

The secondary treatment unit 3 comprises a secondary inlet valve system 36 configured selectively to connect the secondary process gas inlet 30 to the first and second secondary adsorbers 32, 33; and a secondary outlet valve system 39 configured selectively to connect the first and second secondary adsorbers 32, 33 to the secondary process gas outlet 31. The secondary inlet valve system 36 comprises a plurality of secondary inlet control valves 40-n; and the secondary outlet valve system 39 comprises a plurality of secondary outlet control valves 43-n.

The secondary inlet control valves 40-n are configured to control the supply of the untreated (feed) process gas from the secondary process gas inlet 30 to the first and second secondary adsorbers 32, 33. Each of the secondary inlet control valves 40-n is controllable independently by the control unit 5. The secondary inlet control valves 40-n each comprise an actuator, such as a solenoid, which is operable in dependence on a valve control signal. The secondary inlet control valves 40-n are two-way valves in the present embodiment, but other types of valve may be used. For example, the secondary inlet control valves 40-n may be three-way valves. In the present embodiment, the secondary inlet valve system 36 comprises an array of six (6) secondary inlet control valves 40-n arranged in pairs in first, second and third inlet branches 41-1, 41-2, 41-3. The secondary inlet valve system 36 may comprise any other arrangement of secondary inlet control valves 40-n configured to control the supply of the untreated (feed) process gas from the secondary process gas inlet 30 to the first and second secondary adsorbers 32, 33. The secondary process gas inlet 30 is connected to the first inlet branch 41-1 between the first and second secondary inlet control valves 40-1, 40-2. The first and second secondary inlet control valves 40-1, 40-2 are selectively opened and closed to place the secondary process gas inlet 30 in fluid communication with one (or both) of the first and second secondary adsorbers 32, 33. A secondary process gas vent 42 is connected to the second inlet branch 41-2 between the third and fourth secondary inlet control valves 40-3, 40-4. The secondary process gas vent 42 is also connected to the third inlet branch 41-3 between the fifth and sixth secondary inlet control valves 40-5, 40-6. The first and second secondary adsorbers 32, 33 can be controllably vented through the secondary process gas vent 42. The secondary inlet valve system 36 may comprise any other arrangement of secondary inlet control valves 40-n configured to controllably vent the first and second secondary adsorbers 32, 33 through the secondary process gas vent 42.

The secondary outlet control valves 43-n are configured to control the supply of the treated process gas from the first and/or second secondary adsorbers 32, 33 to the other secondary adsorbers or to the secondary process gas outlet 31. The secondary process gas outlet 31 is connected to the regeneration gas supply conduit 4 and, in use, is operative to supply treated process gas from the secondary treatment unit 3 to the primary treatment unit 2 to regenerate the first and second primary adsorbers 12, 13. Each of the secondary outlet control valves 43-n is controllable independently by the control unit 5. The secondary outlet control valves 43-n each comprise an actuator, such as a solenoid, which is operable in dependence on a valve control signal. The secondary outlet control valves 43-n are two-way valves in the present embodiment, but other types of valve may be used. For example, the secondary outlet control valves 43-n may be three-way valves. In the present embodiment, the secondary outlet valve system 39 comprises an array of five (5) secondary outlet control valves 43-n arranged in first, second and third outlet branches 44-1, 44-2, 44-2, 44-3. The secondary outlet valve system 39 may comprise any other arrangement of secondary outlet control valves 43-n configured to control the supply of the treated process gas from the first and/or second secondary adsorbers 32, 33 to the other secondary adsorber or to the secondary process gas outlet 31. The secondary process gas outlet 31 is connected to the first outlet branch 44-1 between the first and second secondary outlet control valves 43-1, 43-2. The first and second secondary outlet control valves 43-1, 43-2 are selectively opened and closed to place one (or both) of the first and second secondary adsorbers 32, 33 in fluid communication with the secondary process gas outlet 31. The first and second secondary outlet control valves 43-1, 43-2 can both be closed to inhibit the supply of treated process gas to the primary treatment unit 2.

A heater supply conduit 37 is provided to supply the treated process gases from one (or both) of the first and second secondary adsorbers 32, 33 to a secondary regeneration heater 45. The heater supply conduit 37 forms a loop between the secondary process gas outlet 31 and the second outlet branch 44-2 of the secondary outlet valve system 39. A first end of the heater supply conduit 37 is connected to the second outlet branch 44-2 between the third and fourth secondary outlet control valves 43-3, 43-4; and a second end of the heater supply conduit 37 is connected to the secondary process gas outlet 3144-2. A secondary regeneration control valve 49 is provided in the heater supply conduit 37 to control the supply of the treated process gas to the secondary regeneration heater 45. The supply of the treated process gas to the secondary regeneration heater 45 is controllable to facilitate regeneration of the first and second secondary adsorbers 32, 33. The second end of the heater supply conduit 37 may alternatively be connected to an additional outlet branch (not shown) having a similar configuration to the first outlet branch 44-1 or the second outlet branch 44-2, the second end of the heater supply conduit 37 may be connected between two additional outlet control valves in a similar configuration to the connection of the first end of the heater supply conduit 37 to the second outlet branch 44-2. The fifth secondary outlet control valve 43-5 is provided in the third outlet branch 44-3 selectively to establish fluid communication between the first and second secondary adsorbers 32, 33. The fifth secondary outlet control valve 43-5 is operated to control re-pressurisation of one of the first and second secondary adsorbers 32, 33 from the other one of the first and second secondary adsorbers 32, 33. The secondary outlet valve system 39 may comprise any other arrangement of secondary outlet control valves 43-n configured to supply the treated process gas to the secondary regeneration heater 45 and to establish fluid communication between the first and second secondary adsorbers 32, 33.

A second heater controller 46 is provided for controlling operation of the secondary regeneration heater 45. The second heater controller 46 may be integrated into the control unit 5 or may be a separate controller. The second heater controller 46 comprises at least one electronic processor having at least one electrical input for receiving first and second secondary temperature signals from respective first and second secondary temperature sensors 47, 48. The first secondary temperature sensor 47 is configured to measure a first operating temperature T1 of the first secondary adsorber 32; and the second secondary temperature sensor 48 is configured to measure a second operating temperature T2 of the second secondary adsorber 33.

The untreated (feed) process gas to the primary treatment unit 2 is supplied from a primary compressor 52 with an above ambient delivery pressure, preferably of 15 barg after it has been cooled down to a summer peak temperature of 33.4° C. The regeneration of the primary treatment unit 2 is carried out using a low energy temperature swing approach with regeneration gas let down in pressure to just above ambient from the secondary treatment unit 3 operating at a feed pressure of 3 barg. The secondary treatment unit 3 is supplied with ambient air that is compressed by a dedicated secondary compressor 53. The air to the primary treatment unit 2 and secondary treatment unit 3 are independently cooled to 5° C. using refrigeration cycles to reduce the water content. An economiser heat exchanger is used to reduce power consumption. The primary treatment unit 2 and the secondary treatment unit 3 are provided to reduce the carbon dioxide (CO2) and water (H2O) content of the process gas. In the present embodiment, the primary treatment unit 2 and the secondary treatment unit 3 reduce the carbon dioxide (CO2) and water (H2O) content of the process gas sufficiently to reduce or prevent freeze-out at low temperatures, for example in the cold-end of the process implemented by the storage plant.

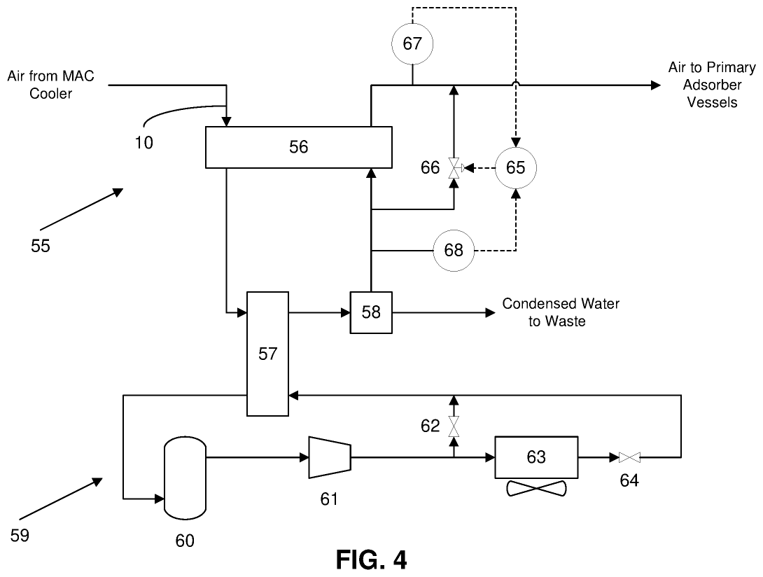

The primary compressor 52 comprises a primary aftercooler 54. The process gas is discharged from the primary aftercooler 54 and introduced into a primary chiller 55 (shown schematically in FIG. 4). The process gas is preferably saturated air and is first cooled in an economiser heat exchanger 56. This reduces the temperature of the process gas to approximately 17° C. and causes condensation of some of the water vapour. The process gas is then further cooled against a refrigerant in a refrigeration heat exchanger 57 to a temperature of approximately 5° C. The condensed water is separated out using a lossless water separator/drain 58 where it can be passed out of the gas treatment apparatus 1 as waste or recycled into another system co-located to the gas treatment apparatus 1. The chilled process gas is reheated by passing it back through the opposite side of the economiser heat exchanger 56. This reheats the process gas, which then passes on to the primary treatment unit 2. The economiser heat exchanger 56 and the refrigeration heat exchanger 57 condense out a substantial portion of the water from the air, and reduce the temperature compared with that discharged from the primary aftercooler 54. A warm-end temperature differential ΔT of the economiser heat exchanger 56 may typically be approximately 10° C. By way of example, a peak (summer) temperature of 33.4° C. from the primary compressor 52 aftercooler will result in a 23.4° C. feed temperature to the adsorber vessel 14-1s. A temperature of 23.4° C. is therefore the design temperature for the adsorption process performed by the primary treatment unit 2. If the economiser heat exchanger 56 is more efficient than expected and the temperature differential ΔT is less than 10° C., there would be a saving in the refrigeration duty. However, this may lead to a higher temperature in the process gas supplied to the primary treatment unit 2. In this scenario, some of the process gas leaving the water separator/drain 58 is bypassed around the economiser heat exchanger 56 to achieve the target process gas temperature (approximately 23.4° C. in the present embodiment) for the primary treatment unit 2. A bypass valve 66 is provided for controllably bypassing the economiser heat exchanger 56. The temperature of the process gas leaving the economiser heat exchanger 56 may be measured by a temperature sensor 67 in communication with a bypass controller 65 configured to open and close the bypass valve 66. The bypass valve 66 may be opened by the bypass controller 65 if the process gas temperature exceeds a target process gas temperature (for example, 23.4° C.). If the process gas temperature is less than the target operating temperature, the bypass valve 66 may be closed (or maintained in a closed state). Instead, the more effective performance of the economiser heat exchanger 56 can be used to reduce the heat load on the refrigeration heat exchanger 57. A refrigerant loop 59 for the refrigeration heat exchanger 57 is shown in FIG. 4. The refrigeration heat exchanger 57 is connected to a refrigerant liquid/vapour separator tank 60, a refrigerant compressor 61, a refrigerant bypass valve 62, an air-cooled refrigerant condenser 63 and an expansion valve 64.

If the temperature of the process gas supplied from the primary aftercooler 54 exceeds a target supply temperature (33.4° C. in the present embodiment), the bypass valve 66 is opened to keep the process gas temperature to the primary treatment unit 2 at the target operating temperature of 23.4° C. However, this may result in the temperature differential ΔT on the warm end of the economiser heat exchanger 56 being greater than 10° C. This may result in an increased load on the refrigeration loop 59. If the refrigeration duty is limited, then the available cooling may be used to condense out water rather than seek to cool the temperature of the process gas to the target operating temperature for supply to the primary treatment unit 2. If the refrigeration duty is too high, this will manifest in an increase in the temperature of the air after the water separator/drain 58. The temperature of the process gas leaving the water separator/drain 58 may be measured by a temperature sensor 68 in communication with the bypass controller 65. A determination that the temperature is increasing can be used to override the bypass controller 65 to close the bypass valve 66. A temperature set-point, for example 7° C., may be defined for the bypass controller 65. If the temperature exceeds the temperature set-point, the bypass controller 65 is configured to close the bypass valve 66.

The refrigerant loop 59 evaporates refrigerant in the refrigeration heat exchanger 57 to provide cooling of the process gas. The gaseous refrigerant is then compressed by the refrigerant compressor 61 before cooling and condensation against ambient air. The temperature of the refrigerant is then further reduced through isenthalpic flash expansion through expansion valve 64 before being sent back to the refrigeration heat exchanger 57. The refrigerant bypass valve 62 is used to prevent too much cooling by the refrigeration unit at low loads and potential freezing out of the water in the process gas within the refrigeration heat exchanger 57. A feed forward control on the refrigeration unit is provided in the case of rapid turn down of process gas flow from the primary compressor 52 to prevent overcooling and freeze out of water in the refrigeration heat exchanger 57.

The process gas from the primary chiller 55 is then sent to the primary treatment unit 2. As outlined above, the primary treatment unit 2 is a two bed, low-thermal-energy adsorption process for the removal of water (H2O). As shown in FIG. 1, the primary treatment unit 2 comprises first and second primary adsorbers 12, 13. In the present embodiment, the primary treatment unit 2 is configured to reduce the water (H2O) content of the process gas to below −100° C. dewpoint and less than 0.1 ppb time-average carbon dioxide (CO2).

The first and second primary adsorbers 12, 13 of the primary treatment unit 2 have like configurations. For the sake of brevity, the configuration of the first primary adsorber 12 is described herein. It will be understood that the second primary adsorber 13 has substantially the same configuration. Process gas from the primary chiller 55 is fed through one of the first and second primary adsorbers 12, 13 at a time while the other one of the first and second primary adsorbers 12, 13 is regenerated. The first primary adsorber 12 comprises a first primary adsorber bed 15-1 disposed in the first primary adsorber vessel 14-1. The second primary adsorber 13 comprises a second primary adsorber bed 15-2 disposed in the second primary adsorber vessel 14-2. The first and second adsorber beds 15-1, 15-2 are primarily designed to remove water (H2O) and carbon dioxide (CO2) from the process gas. In practice, the first and second primary adsorbers 12, 13 may also at least partially remove other components, including one or more of the following Nox, Sox, HCl, C4+ hydrocarbons and acetylene (C2H2). The packed bed layers and two examples of in-bed sensors within the vessel 70 are shown in FIGS. 3A and 3B. The upward flow direction of the process gas through the first primary adsorber 12 during treatment is illustrated in by a continuous arrow; and the downward flow direction of the regeneration gas through the first primary adsorber 12 is illustrated by an interrupted arrow.

In the standard/default design shown in FIG. 3A, the first primary adsorber bed 15-1 comprises at least one adsorbent layer. In the present embodiment, the at least one adsorbent layer comprises a first adsorbent layer 73 and a second adsorbent layer 74. The first adsorbent layer 73 comprises beads of an adsorbent material. The primary adsorber bed 15-1 may comprise additional layers of other materials such as ceramic beads (not shown). The ceramic beads may be provided at the bottom of the first primary adsorber bed 15-1 to knock out water droplets that may be present in the incoming air stream, preventing them getting onto the adsorbent and damaging the active material. Water droplets should not be present in normal operation as the upstream primary chiller 55 reduces the relative humidity of the air to significantly below 100%. However, if the gas treatment apparatus 1 is started up during cold ambient conditions (for example, less than 5° C.), then water could condense out in the upstream pipework before it has reached operating temperature and lead to transfer of water droplets onto the first primary adsorber bed 15-1.

The first adsorbent layer 73 preferably comprises activated alumina in the present embodiment. The primary purpose of the activated alumina is to remove water (H2O) from the process gas, typically down to a maximum dew-point of −40° C. The activated alumina can also remove a portion of the carbon dioxide (CO2) from the process gas, especially so if it is base treated with Potassium carbonate (K2CO3) or sodium carbonate (Na2CO3). The carbon dioxide (CO2) reacts with the base compound in the presence of water (H2O) to convert carbonate to bicarbonate. The equation for the chemical reaction is as follows:

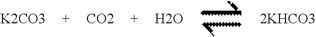

This chemical reaction is reversible with the application of heat during a regeneration process, allowing the carbon dioxide (CO2) to disassociate from the alumina.

The drier process gas leaving the layer of activated alumina in the first primary adsorber bed 15-1 is passed through the second adsorbent layer 74. In the present embodiment, the second adsorbent layer 74 comprises or consists of a molecular sieve, such as 13X molecular sieve. The molecular sieve will remove residual water, typically down to a level below a dew-point of −100° C. The molecular sieve is preferably sized to remove the carbon dioxide (CO2) down to a time-average breakthrough of 100 ppb (0.1 ppm) with a peak concentration of no more than 1 ppm. The carbon dioxide (CO2) exits the molecular sieve in an exponential fashion over time.

One or more temperature sensor 77A may be provided in each of the first and second primary adsorber beds 15-1, 15-2. Each temperature sensor may output a temperature signal to the electronic control unit 5 to facilitate control of the regeneration process. The one or more temperature sensor 77A may be located within any of the at least one adsorbent layer. In the embodiment shown in FIG. 3A, a first temperature sensor 77A is located within the first adsorbent layer 73 to measure the operating temperature of the process gas. The first temperature sensor 77A is a thermocouple in the present embodiment. The implementation of a low energy regeneration cycle is facilitated by measuring the operating temperature in the first adsorbent layer 73. The first temperature sensor 77A can be spaced apart from the bottom of the first adsorbent layer 73, for example approximately placed 100 mm above the bottom of the alumina layer. The first temperature sensor 77A is preferably radially inset from a sidewall of the vessel 14-1, for example approximately 300 mm from the sidewall. The first temperature sensor 77A is provided to enable in-bed measurements of the operating temperature of the first primary adsorber bed 15-1. Alternatively, or in addition, a temperature sensor may be provided at the top of the first primary adsorber bed 15-1 to measure the regeneration gas temperature as it enters the adsorbent, rather than simply after the primary regeneration heater 25. This helps to determine the amount of heat loss between the heater and the adsorber bed. In the embodiment shown in FIG. 3B, a second temperature sensor 77B is provided at the interface between the first and second adsorbent layers 73, 74. In the present embodiment, the second temperature sensor 77B is radially inset from the sidewall of the vessel 14-1, for example approximately 300 mm from the sidewall. The second temperature sensor 77B is a thermocouple in the present embodiment. The second temperature sensor 77B enables determination of the amount of heat used to remove the carbon dioxide (CO2) and how much is left to desorb water (H2O) from the activated alumina. A third temperature sensor 77C is provided in the second adsorbent layer 74. In the illustrated arrangement, the third temperature sensor 77C is provided at the top of the second adsorbent layer 74.

Each of the first and second primary adsorbers 12, 13 may optionally comprise at least one carbon dioxide (CO2) sensor 77D; and/or at least one water (moisture) H20 sensor 77D. The carbon dioxide (CO2) sensor and/or the water (H2O) sensor 77D may be provided in the first adsorbent layer 73. Alternatively, or in addition, the carbon dioxide (CO2) sensor and/or the water (H2O) sensor 77D may be provided in the second adsorbent layer 74. In use, the sensors 77D may monitor the water (H2O) and/or carbon dioxide (CO2) content of the process gas within the first primary adsorber bed 15-1. One or more sensors 77D may be placed in the second adsorbent layer 74 below the top of the second adsorbent layer 74, for example 100 mm below the top of the second adsorbent layer. The one or more sensors 77D may be configured to monitor carbon dioxide (CO2) in the second adsorbent layer 74, for example to determine how close the carbon dioxide (CO2) is to breaking through the first primary adsorber bed 15-1 before it actually occurs. One of the sensors 77D may take a sample of the process gas next to the sidewall to check for channeling of carbon dioxide (CO2) down the sides of the vessel and the other may be in a location spaced apart from the sidewall, for example disposed 300 mm inboard of the sidewall, to measure the bulk process gas. A similar set of sensors 77D may be provided in the first adsorbent layer 73, for example located 100 mm below the top of the first adsorbent layer 73 to allow monitoring of water (H2O) and/or carbon dioxide (CO2) progressing through the first adsorbent layer 73. Alternatively, or in addition, the carbon dioxide (CO2) sensor 77D; and/or the at least one water (moisture) H20 sensor 77D may be provided at the interface between the first and second adsorbent layers 73, 74. In the present embodiment, the configuration of the sensors 77D is at least substantially the same in the first and second primary adsorbers 12, 13. It will be understood that the configuration of the sensors 77D may be different in the first and second primary adsorbers 12, 13.

Each of the first and second primary adsorbers 12, 13 is sized for a feed time of six (6) hours, after which regeneration is performed to remove the adsorbed water (H2O) and carbon dioxide (CO2). The first and second primary adsorbers 12, 13 may be sized for a different feed time which may be longer or shorter than six (6) hours. It will be understood that a feed time which is less than or more than six (6) hours can be performed. The regeneration is achieved through the opening and closing of the primary inlet control valves 20-n in the primary inlet valve system 16; and the opening and closing of the primary outlet control valves 23-n in the primary outlet valve system 19. As described herein, the first and second primary adsorber beds 12, 13 are subjected to a plurality of operating steps. In the present embodiment, the operating steps comprise: Feed, Depressurisation, Heating, Cooling and Re-pressurisation. The heating process is performed to regenerate the first primary adsorber bed 15-1. These processes are implemented by the first and second primary adsorber beds 12, 13. To enable continuous operation of the gas treatment apparatus 1, the first and second primary adsorber beds 12, 13 operate in different cycles. In particular, while one of the first and second primary adsorber beds 12, 13 is operating in the feed process, the other one of the first and second primary adsorber beds 12, 13 is regenerated. The different operating cycles of the first and second primary adsorber beds 12, 13 are referred to herein as the first and second operating modes. The gas treatment apparatus 1 is operated in the first and second operating modes. The gas treatment apparatus 1 is cycled between the first and second operating modes. One of the first and second primary adsorber beds 15-1, 15-2 is configured to treat the process gas while the other one of the first and second primary adsorber beds 15-1, 15-2 is regenerated.

When operating in the first operating mode, the first primary adsorber bed 15-1 operates in the feed process and is supplied with the untreated (feed) process gas from the primary process gas inlet 10. The first primary adsorber bed 15-1 discharges the treated process gas to the primary process gas outlet 11. In the first operating mode, the second primary adsorber bed 15-2 is connected to the secondary process gas outlet 31 to receive treated process gas from the secondary treatment unit 3. The process gas from the secondary treatment unit 3 is supplied to the primary treatment unit 2 to regenerate the second primary adsorber 15-2. The process gas supplied from the secondary treatment unit 3 may optionally be heated by the primary regeneration heater 25.

When operating in the second operating mode, the second primary adsorber bed 15-2 operates in the feed process and is supplied with the untreated (feed) process gas from the primary process gas inlet 10. The second primary adsorber bed 15-2 discharges the treated process gas to the primary process gas outlet 11. In the second operating mode, the first primary adsorber bed 15-1 is connected to the secondary process gas outlet 31 to receive treated process gas from the secondary treatment unit 3. The process gas from the secondary treatment unit 3 is supplied to the primary treatment unit 2 to regenerate the first primary adsorber 15-1. The process gas supplied from the secondary treatment unit 3 may optionally be heated by the primary regeneration heater 25.

In order to achieve a cyclic process with the first and second primary adsorbers 12, 13, the total time for all the other operating steps is preferably the same as or less than the feed time for treating the process gas. In the present embodiment, the following operating times have been defined for each of the operating steps:
Feed: 360 minutes
Depressurisation: 30 minutes
Heating: 40 minutes
Cooling: 260 minutes
Re-pressurisation: 30 minutes

The above operating times are provided by way of example only. It will be understood that different operating times may be applied in respect of one or more of the operating processes. For example, different operating times may be implemented for first and second primary adsorbers 12, 13 having different capacities.

The different operating steps will now be described with respect to the first primary adsorber bed 12. It will be understood that like operating steps are performed by the second primary adsorber bed 13.

During the feed step, the process gas is passed upwards through the first primary adsorber bed 15-1 to remove the unwanted contaminants. The treated process gas is then sent on to the downstream process units. In the first operating mode, the feed step is performed by the first primary adsorber bed 15-1. In the second operating mode, the feed step is performed by the second primary adsorber bed 15-2.

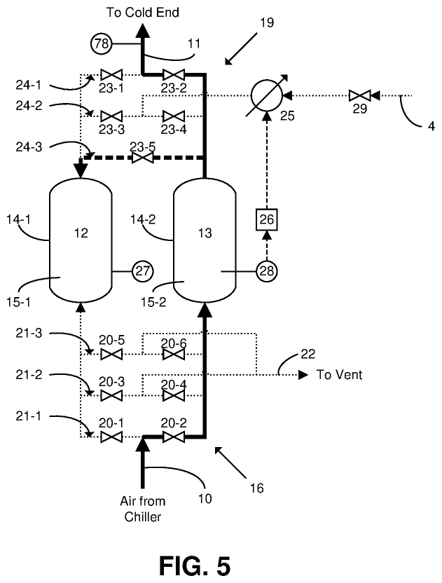

In the configuration of the gas treatment apparatus 1 shown in FIG. 5, the second primary adsorber 13 performs a feed step to treat the process gas. The flow of the process gas during this step is illustrated in FIG. 5 by the solid thick line. The gas treatment apparatus 1 is configured to control the primary inlet control valves 20-n and the primary outlet control valves 23-n to control the flow of the process gas. In the arrangement illustrated in FIG. 5, the second primary inlet control valve 20-2 and the second primary outlet control valve 23-2 are opened; and the fourth and sixth primary inlet control valves 20-4, 20-6 and the fourth primary outlet control valve 23-4 are closed. As described herein, the fifth primary outlet control valve 23-5 may be selectively opened to supply treated process gas to the first primary adsorber 12 to re-pressurise the first primary adsorber 12. The primary process gas inlet 10 is connected to the second primary adsorber 13. In particular, the primary inlet valve system 16 is configured to supply the untreated (feed) process gas to the second primary adsorber 13. The second primary adsorber 13 is placed in fluid communication with the primary process gas inlet 10. In use, the untreated (feed) process gas is supplied from the primary process gas inlet 10 and passes through the second primary adsorber bed 15-2 to remove water (H2O) and carbon dioxide (CO2). The treated process gas is discharged from the second primary adsorber 13 to the primary process gas outlet 11. The second primary adsorber 13 is placed in fluid communication with the primary process gas outlet 11.

The primary outlet valve system 19 can be selectively configured to connect the second primary adsorber 13 to the primary process gas outlet 11. The flow of the treated process gas from the second primary adsorber 13 to the first primary adsorber 12 is illustrated in FIG. 5 by the interrupted (broken) thick line. The supply of the treated process gas to the first primary adsorber 12 may, for example, be performed at least partially to re-pressurise the first primary adsorber vessel 14-1 (for example, following regeneration of the first primary adsorber bed 15-1). The first primary adsorber 12 is placed in fluid communication with the second primary adsorber 13. The primary inlet valve system 16 is configured to close an inlet of the second primary adsorber 13. The primary outlet valve system 19 opens the fifth primary outlet control valve 23-5 to enable the third branch 24-3 to function as a re-pressurisation conduit. A portion of the treated process gas discharged from the second primary adsorber 13 is introduced into the first primary adsorber 12. The treated process gas at least partially re-pressurises the first primary adsorber vessel 14-1. The fifth primary outlet control valve 23-5 may be configured to control the proportion of the treated process gas discharged from first primary adsorber 12 to each of the primary process gas outlet 11 and the second primary adsorber 12. The fifth primary outlet control valve 23-5 may be a variable flow control valve or a proportional control valve to control the supply of treated process gas. The supply of the treated process gas to the first primary adsorber 12 may be controlled independently of the operation of the second primary adsorber 13 to treat the process gas.

Alternatively, or in addition, the first primary adsorber vessel 14-1 may be at least partially re-pressurized using the regeneration gas from the secondary treatment unit 3. The outlet of the first primary adsorber 12 may be closed and the regeneration gas from the secondary treatment unit 3 may be supplied at least partially to re-pressurize the first primary adsorber vessel 14-1. In the present embodiment, the outlet of the first primary adsorber 13 may be closed by closing the first, third and fifth primary inlet control valves 20-1, 20-3, 20-5. Other valve configurations may be used to close the outlet of the first primary adsorber 12. Alternatively, or in addition, the primary compressor 52 may supply untreated (feed) process gas to re-pressurize the first primary adsorber vessel 34-1.

A carbon dioxide (CO2) analyser 78 monitors the concentration of the carbon dioxide (CO2) in the primary process gas outlet 11. The carbon dioxide (CO2) analyser 78 is configured to detect if the carbon dioxide (CO2) content of the treated process gas is greater than a predetermined carbon dioxide (CO2) threshold. The preferable carbon dioxide (CO2) threshold in the present embodiment is defined as 1 ppm to prevent freeze out in the downstream equipment. The carbon dioxide (CO2) analyser 78 may optionally be configured to generate an alert if the detected carbon dioxide (CO2) is 0.2 ppm and/or 0.5 ppm. A standard air separation unit (ASU) CO2 analyser will typically be calibrated for operation in the ppm range, with a lower detectable limit close to 0.2 ppm. The carbon dioxide (CO2) analyser 78 may optionally be configured to measure the carbon dioxide (CO2) in an oxygen O2 sump where the carbon dioxide (CO2) is concentrated up to a level that is much easier to detect with a ppm analyser. In the present embodiment, the carbon dioxide (CO2) analyser 78 is a ppb analyser for accurately measuring the concentrations of interest. The carbon dioxide (CO2) analyser 78 may optionally be provided in a temperature-controlled cabinet to reduce variations due to changes in the ambient temperature. A nitrogen (N2) zero gas for the carbon dioxide (CO2) analyser 78 should contain as close to zero carbon dioxide (CO2) as practicable. A similar carbon dioxide (CO2) analyser 79 may be used to monitor the concentration of the carbon dioxide (CO2) in the secondary process gas outlet 31.

A water (H2O) analyser may optionally be provided in the primary process gas outlet 11. However, if the carbon dioxide (CO2) has been removed, the treated process gas is generally too dry for a dew-point reading to be meaningful. As such, it is not essential to provide a water (H2O) analyser.

In a variant, the feed process may continue until carbon dioxide (CO2) breakthrough is detected. However, accurate monitoring is preferred to avoid water (H2O) being fed into the second adsorber layer 74 (comprising the molecular sieve) before CO2 breaks through. It helps avoid the need to remove water (H2O) from the second adsorber layer 74 which can prove difficult.

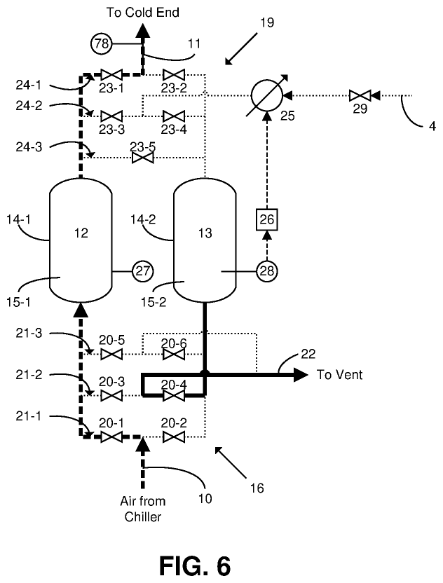

The primary treatment unit 2 transitions from the second operating mode to the first operating mode. The first primary adsorber 12 performs a feed step to treat the process gas in which the untreated (feed) process gas is supplied to the first primary adsorber bed 15-1. The flow of the process gas during this step is illustrated in FIG. 6 by the interrupted thick line. The gas treatment apparatus 1 is configured to control the primary inlet control valves 20-n and the primary outlet control valves 23-n to control the flow of the process gas. In the arrangement illustrated in FIG. 6, the first primary inlet control valve 20-1 and the first primary outlet control valve 23-1 are opened; and the third and fifth primary inlet control valves 20-3, 20-5 and the third primary outlet control valve 23-3 are closed. As described herein, the fifth primary outlet control valve 23-5 may be opened to selectively supply treated process gas to the second primary adsorber 13. As shown in FIG. 6, the primary process gas inlet 10 is connected to the first primary adsorber 12. The primary inlet valve system 16 is configured to supply the untreated (feed) process gas to the first primary adsorber 12. The first primary adsorber 12 is placed in fluid communication with the primary process gas inlet 10. In use, the untreated (feed) process gas is supplied from the primary process gas inlet 10 and is treated by the first primary adsorber bed 15-1 to remove water (H2O) and carbon dioxide (CO2). The treated process gas is discharged from the first primary adsorber 12 to the primary process gas outlet 11.

While the first primary adsorber bed 15-1 is active to treat the process gas, the second primary adsorber bed 15-2 is regenerated. The second primary adsorber 13 is first de-pressurized in a depressurisation step, preferably to atmospheric pressure. The flow of the process gas during this step is illustrated in FIG. 6 by the solid thick line. In the present embodiment, the depressurisation is performed over a period of thirty (30) minutes with the gas vented to atmosphere. The third and fourth primary inlet control valves 20-3, 20-4 are controlled to connect the second primary adsorber 13 to the primary process gas vent 22. The vented gas may be slightly O2 depleted compared with air since the second primary adsorber bed 15-2 preferentially adsorbs a small amount of N2 that is now released during the depressurisation step. The vented gas may alternatively be captured and stored or used by another system co-located to the gas treatment apparatus 1.

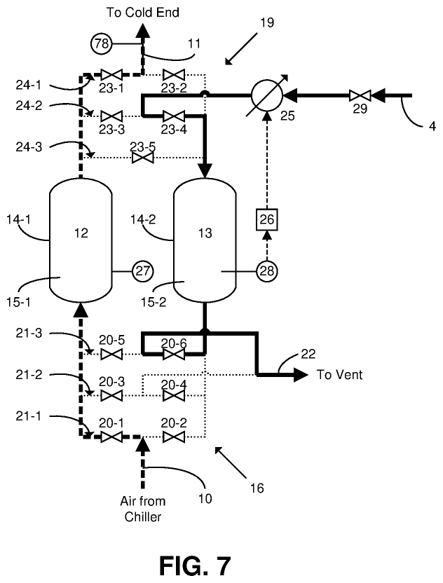

As shown in FIG. 7, the second primary adsorber bed 15-2 is then regenerated in a regeneration step. The flow of the process gas during this step is illustrated in FIG. 7 by the solid thick line. The gas treatment apparatus 1 is configured to control the primary inlet control valves 20-n and the primary outlet control valves 23-n to control the flow of the process gas. In the arrangement illustrated in FIG. 7, the sixth primary inlet control valve 20-6 and the fourth primary outlet control valve 23-4 are opened; and the second and fourth primary inlet control valves 20-2, 20-4 and the second and fifth primary outlet control valves 23-2, 23-5 are closed. Regeneration gas is supplied to the second primary adsorber bed 15-2 from the secondary treatment unit 3. The regeneration gas in the present embodiment is treated process gas. As described herein, the treated process gas comprises air which has been treated to remove water (H2O) and carbon dioxide (CO2). The third and fourth primary outlet control valves 23-3, 23-4 are configured to place the regeneration gas supply conduit 4 in fluid communication with the second primary adsorber 13. The second primary adsorber 13 is maintained in fluid communication with the primary process gas vent 22. The regeneration gas is the process gas which has been treated by the secondary treatment unit 3. The regeneration gas is substantially free of carbon dioxide (CO2) and water (H2O). The regeneration gas is passed through the primary regeneration heater 25 and heated to a predetermined target temperature. In the present embodiment, the target temperature is 230° C., although this is set by the specific design of the system and may vary depending on the system design. The heating of the regeneration gas is performed in the heating step. The heated regeneration gas flows through the de-pressurized first primary adsorber bed 15-1, causing water (H2O) and carbon dioxide (CO2) to desorb from the second primary adsorber bed 15-2 and vented through the primary process gas vent 22. The primary process gas vent 22 is preferably located distal from the inlets of the primary compressor 52 and secondary compressor 53 as the carbon dioxide (CO2) is concentrated in the exiting regeneration gas and it would be undesirable to feed this back into the gas treatment apparatus 1. The vented gas may alternatively be captured and stored or used by another system co-located to the gas treatment apparatus 1. As shown in FIG. 7, the gas treatment apparatus 1 is configured such that the first primary adsorber 12 is operative to treat the untreated (feed) process gas supplied to the primary process gas inlet 10 while the second primary adsorber 13 is regenerated. The treated process gas from the first primary adsorber 12 is discharged from the first primary adsorber 12 to the primary process gas outlet 11.

The temperature at the exit of the primary regeneration heater 25 is monitored and the electric heat input varied to maintain the target temperature of 230° C. Temperature measurements on the shell of the heater are performed to make sure that local overheating does not occur. The flow rate of the treated process gas from the secondary treatment unit 3 may be monitored and the power to the primary regeneration heater 25 reduced or inhibited if the flow rate is below a lower flow threshold.

The regeneration of the first and second primary adsorber beds 15-1, 15-2 in the present embodiment is carried out in a downflow direction as the concentration of water (H2O) in the regeneration gas is increased due to heating. The water (H2O) can be condensed out by cooling on the outlet vessel head. By regenerating in the downflow direction, this condensed water is pushed out towards the primary process gas vent 22. In an up-flow arrangement the condensed water may instead fall back down onto the adsorbent, potentially causing material degradation issues due to contact with liquid water. The use of downflow regeneration may reduce or ameliorate these problems.

After approximately forty (40) minutes, the primary regeneration heater 25 is turned off. However, the regeneration gas is continued to be supplied to the second primary adsorber bed 15-2 through the primary regeneration heater 25. This allows the residual heat in the primary regeneration heater 25 and pipework to be pushed into the first primary adsorber 12. After the primary regeneration heater 25 is cooled, the supply of the regeneration gas continues to push the heat down through the second primary adsorber bed 15-2 and continues to remove water (H2O) and carbon dioxide (CO2). Around two-hundred and sixty (260) minutes after the primary regeneration heater 25 is switched off, the supply of the regeneration gas from the secondary treatment unit 3 is stopped. This signals the end of the cooling step.

The regeneration of each of the first and second primary adsorber beds 15-1, 15-2 may be performed independently of the operation of the other one of the first and second primary adsorber beds 15-1, 15-2. At least in certain embodiments, the regeneration of the first primary adsorber bed 15-1 may be performed while the second primary adsorber bed 15-2 is operating to treat the (untreated) process gas supplied from the primary process gas inlet 10. Similarly, the regeneration of the second primary adsorber bed 15-2 may be performed while the first primary adsorber bed 15-1 is operating to treat the (untreated) process gas supplied from the primary process gas inlet 10.

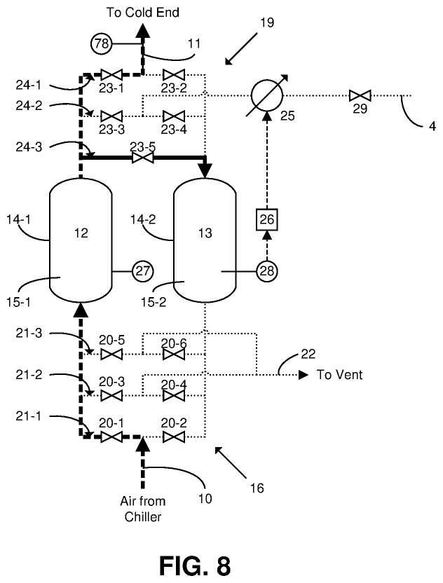

As shown in FIG. 8, the second primary adsorber vessel 14-2 is then re-pressurized in a re-pressurisation step. The flow of the process gas during this step is illustrated in FIG. 8 by the solid thick line. The gas treatment apparatus 1 is configured to control the primary inlet control valves 20-n and the primary outlet control valves 23-n to control the flow of the process gas. In the arrangement illustrated in FIG. 8, the first primary inlet control valve 20-1 and the first and fifth primary outlet control valves 23-1, 23-5 are opened. The second, third, fourth, fifth and sixth primary inlet control valves 20-2, 20-3, 20-4, 20-5, 20-6 and the second, third and fourth primary outlet control valves 23-2, 23-3, 23-4 are closed. The re-pressurisation of the second primary adsorber vessel 14-2 may, for example, be performed over a period of approximately thirty (30) minutes. The re-pressurisation in the present embodiment comprises supplying a portion of the treated process gas discharged from the first primary adsorber 12 to the second primary adsorber 13. In particular, a portion of the treated process gas discharged from the first primary adsorber vessel 14-1 to the second primary adsorber vessel 14-2. The fifth primary outlet control valve 23-5 is opened to supply a portion of the treated process gas from the first primary adsorber vessel 14-1 to the second primary adsorber vessel 14-2. The fifth primary outlet control valve 23-5 may be configured to control the proportion of the treated process gas discharged from first primary adsorber 12 to each of the primary process gas outlet 11 and the second primary adsorber 12. The fifth primary outlet control valve 23-5 may be a variable flow control valve or a proportional control valve to control the supply of treated process gas. Alternatively, a flow restrictor may be provided to control the supply of the treated process gas. In the present embodiment, the first primary adsorber vessel 14-1 is re-pressurized from the top with flow in the downwards direction. In a variant, the re-pressurisation may be performed from the bottom with flow in the upwards direction.

Alternatively, or in addition, the second primary adsorber vessel 14-2 may be at least partially re-pressurized using the regeneration gas from the secondary treatment unit 3. The outlet of the second primary adsorber 13 may be closed and the regeneration gas from the secondary treatment unit 3 may be supplied at least partially to re-pressurize the second primary adsorber vessel 14-2. Alternatively, or in addition, the primary compressor 52 may supply untreated (feed) process gas to re-pressurize the second primary adsorber vessel 34-2. In the present embodiment, the outlet of the second primary adsorber 13 may be closed by closing the second, fourth and sixth primary inlet control valves 20-2, 20-4, 20-6. Other valve configurations may be used to close the outlet of the second primary adsorber 13. Alternatively, or in addition, the primary compressor 52 may supply untreated (feed) process gas to re-pressurize the second primary adsorber vessel 34-2.

After the pressure in the vessel 14-1 is at least substantially equalised with the pressure in the primary process gas inlet 10 supplied from the primary compressor 52, the primary treatment unit 2 can change from the first operating mode to the second operating mode. The first and second primary adsorbers 12, 13 are swapped such that the process gas is treated by the second primary adsorber 13. The first primary adsorber 12 can then be regenerated. In the present example, the first primary adsorber 12 previously on feed undergoes regeneration, starting with depressurisation. The second primary adsorber bed 15-2 coming on feed is as closely equilibrated in pressure with the process gas supplied to the primary process gas inlet 10. If the pressure is not equalised, there can be a sudden inrush of process gas upon re-configuring the primary inlet valve system 16 to supply the process gas from the primary compressor 52. This abrupt change may cause the adsorbent to “bump” into the air. This can result in abrasion and dust formation, resulting in higher pressure drops and a loss of adsorber performance. The controller may check that the pressure differential between the two beds is small enough, before opening the primary inlet valve system 16. This differential pressure check is performed in respect of the feed inlet end of the first and second primary adsorber vessels 14-1, 14-2 as this is where the difference will be greatest.

The primary inlet control valves 20-n in the present embodiment are 3-lever valves which cannot be opened if there is a large pressure differential across them. This physically prevents the valves being opened if there is still a large pressure differential between the feed process gas and the first primary adsorber bed 15-1 being re-pressurized. Additional bypass valves may be provided to pressurise the first primary adsorber bed 15-1 on start-up. Other types of valves may be used for the primary inlet control valves 20-n.

The second primary adsorber bed 15-2 is equalised at the process gas supply end and there is a pressure-drop over the first primary adsorber bed 15-1 on feed due to the gas flow through it, whilst the pressure-drop over the second primary adsorber bed 15-2 on re-pressurisation is essentially zero. Therefore, whilst the product (output) end pressures of the first and second primary adsorber bed 15-1, 15-2 at the end of re-pressurisation will be equal, those at the feed (input) end will not be. If the pressure-drop over the first primary adsorber bed 15-2 on feed is too great (e.g. >200 mbar), then the feed inlet pressure will be higher than that of the re-pressurized bed. This could mean that the pressure-drop over the primary inlet control valves 20-n at the feed end of the second primary adsorber bed 15-2 will be too great. This may prevent opening of 3-lever valves. The pressure-drop over the adsorber bed is maintained less than a pressure differential threshold which defines an upper limit against which the 3-lever valve may be opened. It would be possible in operation to manually open the bypass valve around the 3-lever valve on the feed side to reduce the pressure differential and allow the 3-lever valve to open.

The closing of the valves on the first primary adsorber bed 15-1 currently on feed is not initiated until a determination has been made that the valves on the second primary adsorber bed 15-2 coming onto feed are completely open. This is to prevent a lack of continuity of flow through the process from the primary compressor 52.

The total heating and cooling time during the regeneration step discussed above is preferably specified as five (5) hours, but in operation the heating time may be varied. The cooling time may be changed by the appropriate amount to keep to the five (5) hour total regeneration time. The heat time is preferably specified to achieve a 70° C. peak temperature at the in-bed first temperature sensor 77A during the regeneration step. The heat time is calculated based on the amount of water (H2O) and carbon dioxide (CO2) entering the vessel 14-1 during the feed step and a feed-back loop as to what the peak temperature was at this location on the previous regeneration cycle(s). If the concentration of the water (H2O) and carbon dioxide (CO2) in the feed does not vary greatly, measuring the accumulated amount of process gas supplied into the first primary adsorber bed 15-1 during the feed step to that bed prior to regeneration provides a sufficient indicator of the quantity of contaminants in the vessel 14-1. The heating time can be calculated as follows:

$$Heating Time = f ( Previous in - bed temperature peaks ) \times Feed Time \times Feed Flow$$

The f factor is the output of a proportional-integral controller monitoring the previous in-bed temperature peaks for that vessel 14-1 and targeting a setpoint of 70° C.

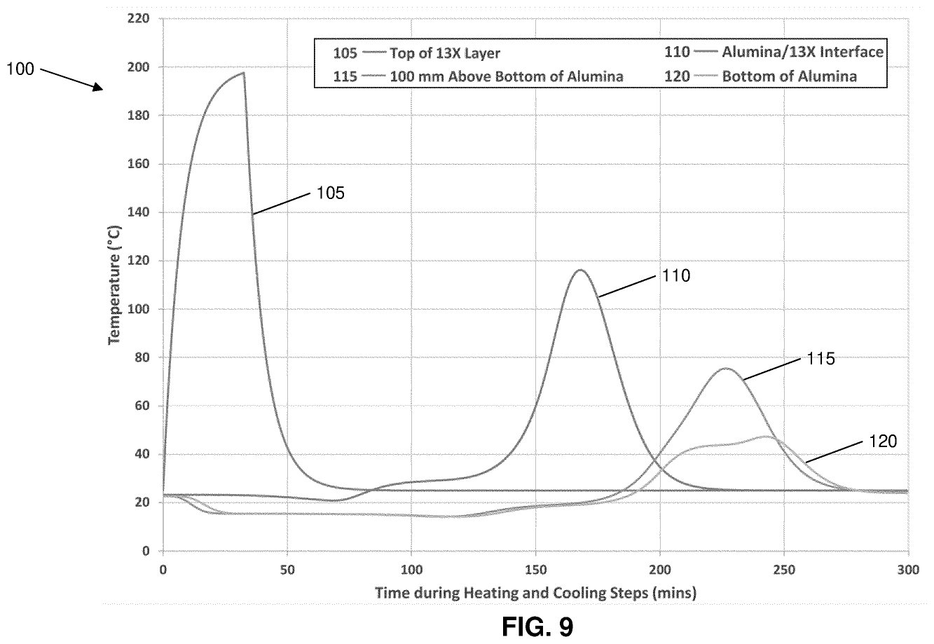

A first plot 100 of the simulated temperature within the first primary adsorber bed 15-1 during regeneration is shown in FIG. 9. A first plot 105 represents the temperature at the top of the first primary adsorber bed 15-1 (after heat loss in the pipe from the heater), measured by the temperature sensor 77C. A second plot 110 represents the temperature at the interface between the first and second adsorbent layers 73, 74, measured by the temperature sensor 77B. A third plot 115 represents the in-bed temperature in the first adsorbent 73 (measured by the first temperature sensor 77A at a distance 100 mm from the bottom of the first adsorbent layer 73). A fourth plot 120 represents the outlet temperature from the first primary adsorber bed 15-1. A heat pulse moves through the first primary adsorber bed 15-1 and its temperature decreases as energy is consumed for desorption of the carbon dioxide (CO2) and water (H2O). At the outlet/bottom of the first primary adsorber bed 15-1 the maximum temperature reached is 45° C., representing a significant proportion of the heat supplied by the primary regeneration heater 25 is used within the first primary adsorber bed 15-1 for regeneration of the adsorbent, with very little wasted to vent. It will be appreciated that this form of operation of the first adsorption bed 15-1 means that not all the water (H2O) is removed from the adsorber (activated alumina) during regeneration, in a similar manner to a pressure swing adsorption process. However, by maintaining the same peak temperature at the in-bed temperature position each regeneration, long-term build-up of water in the first primary adsorber bed 15-1 may be reduced and a steady-state obtained.

It is possible to change how much water is left on the first primary adsorber bed 15-1 at the end of each cycle by choosing different set-points for the peak in-bed temperature. Higher values will result in more energy input to the system and less water on the first primary adsorber bed 15-1 at the end of regeneration. Lower values will result in less energy input and more water on the bed.

As described herein, the re-pressurisation of the first primary adsorber bed 15-1 uses part of the treated process gas discharged from the second primary adsorber bed 15-2 on its feed step, as illustrated in FIG. 5, which means that there is a temporary drop in the flowrate through the primary process gas outlet 11 to the cold end of the process. The flow rate of gas to re-pressurise the first primary adsorber bed 15-1 is highest at the start of re-pressurisation when flow through the fifth primary outlet control valve 23-5 is choked. By way of example, a flow rate of approximately 1700 Nm3/h equates to about 2.4% of the process gas flow rate. Over the duration of the re-pressurisation step (approximately thirty (30) minutes in the present embodiment) the accumulated loss of treated process gas is about 1.8% and measured in comparison to the amount of treated process gas produced during an entire cycle this equates to a loss of 0.15%. As well as consuming treated process gas, the re-pressurisation step also causes a notable increase in the temperature of the second adsorbent layer 74 (which may be composed of molecular sieve). This is due to the adsorption of N2 and 02 during the re-pressurisation step, releasing heat into the bed. A parallel step may optionally by employed in which both the first and second adsorber beds 15-1, 15-2 are put onto feed for a period of time to mitigate the temperature variation in the combined treated process gas. By way of example, the parallel feed step may be performed for forty (40) minutes to reduce the temperature variation. A potential downside of adding a parallel step is that it may reduce the amount of time available for heating and cooling, which may require a higher regeneration flow rate and therefore a larger secondary treatment unit 3. The gas treatment apparatus 1 in the present embodiment operates without a parallel feed step for the first and second adsorber beds 15-1, 15-2.

During the re-pressurisation step, nitrogen N2 in the re-pressurisation gas is preferentially adsorbed over oxygen O2. This means that on the subsequent feed step, that the treated process gas contains a higher concentration of oxygen O2 than air. The oxygen O2 and nitrogen N2 concentrations settle out over a period of time, for example twenty (20) minutes, during which the molecular sieve cools following re-pressurisation. This causes some additional nitrogen N2 in the feed gas to be adsorbed so that the oxygen O2 concentration is a little higher in the treated process gas than the untreated process gas during this time.

Each thermal regeneration of the adsorbent causes some of the activated alumina in the first adsorbent layer 73 to covert from its base state of aluminium oxide to aluminium hydroxide. The chemical equation is as follows:

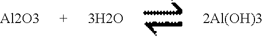

This reaction is favourable to the formation of aluminium hydroxide at low temperatures, but kinetically limited. It is only during the regeneration step when the temperature of the first primary adsorber bed 15-1 increases well above that of the feed temperature of the process gas that the reaction rate becomes appreciable. Aluminium hydroxide has zero capacity for adsorbing water and hence it results in a loss in performance. It is possible to covert the alumina hydroxide back into aluminium oxide, but this requires temperatures in the range of 400° C.-600° C., well above what could be practically done in situ. Conversion to aluminium hydroxide should therefore be treated as irreversible and all the activated alumina would eventually be lost in this manner if the process was run long enough.

The design of the first and second adsorber beds 15-1, 15-2 relies on putting a substantial amount of additional activated alumina into the first adsorbent layer 73 than needed to account for “ageing” of the material over time. This reduces the number of change outs of material required, but it should be expected that a reload of adsorbent will be required at some point during the lifetime of the process.

Being thermally driven, the rate of degradation of the activated alumina can be reduced by running with a low regeneration temperature into the alumina layer, as per the cycle design for the regeneration process. Running with a higher regeneration temperature, or greater heating time will increase the rate of adsorbent ageing and should be avoided unless to counter excessive CO2 breakthrough.

The second adsorbent layer 74 comprising the molecular sieve will typically not age over time if it is only used for carbon dioxide (CO2) removal and not exposed to water. Nitrogen (N2), oxygen (O2) and carbon dioxide (CO2) are unlikely to damage the structure of the molecular sieve, even in the presence of heat. The performance of the molecular sieve can deteriorate if water from the first adsorbent layer 73 begins to break through in substantial amounts. The water (H2O) is preferentially adsorbed, meaning that there is less capacity for the molecular sieve to adsorb CO2, reducing the amount that can be taken out of the feed gas and shortening the time to breakthrough.

Thermal regeneration removes water from the molecular sieve in the second adsorbent layer 74 during each regeneration cycle, but if the amount of water is substantial, the use of a low energy cycle means that it can take many regeneration cycles to remove all of the water. Running with an extended heating time can help in this regard and eventually recover all of the capacity of the molecular sieve to remove carbon dioxide.

The gas treatment apparatus 1 may be configured for continuous operation. One of the first and second adsorber beds 15-1, 15-2 is supplied with the untreated (feed) process gas during a feed step for six (6) hours; and the other one of the first and second adsorber beds 15-1, 15-2 is regenerated. After every six (6) hours, the first and second adsorber beds 15-1, 15-2 are swapped over and the process starts again.

The gas treatment apparatus 1 may be configured for intermittent operation. The primary treatment unit 2 and/or the secondary treatment unit 3 may operate intermittently. At least in certain embodiments, the primary treatment unit 2 or secondary treatment unit 3 may operate independently of the other. The secondary treatment unit 3 may continue operating when the primary treatment unit 2 is inoperative (e.g., offline), for example to supply regeneration gas to regenerate the first primary adsorber bed 15-1 and/or the second primary adsorber bed 15-2 independently of whether the other adsorber bed is undergoing a feed, re-pressurisation or depressurisation step. The adsorption process may be stopped when one of the first and second adsorber beds 15-1, 15-2 is at an operating pressure. Mass transfer may occur through the adsorber bed by diffusion of water (H2O) and carbon dioxide (CO2). If the adsorber bed is held at pressure, the spreading of the water (H2O) and carbon dioxide (CO2) may be relatively small. The total achievable feed times after being brought back on-conduit may be close to the six (6) hour design time described herein. Therefore, assuming that the primary adsorber bed 15-1 on feed will be sealed when the liquid air energy storage plant is shut down and brought back on-conduit without bumping the adsorbent, then intermittent operation may be performed with negligible impact on performance of the feed process.

For the regeneration step, it is preferable to continue the heating and cooling steps once they have started. If the regeneration step is put on hold, the heat pulse inside the first primary adsorber bed 15-1 can disperse, causing water (H2O) in particular to desorb and migrate to places where it can re-adsorb and may cause problems. For example, the water (H2O) may be adsorbed in the second adsorbent layer 74. The low pressure and high temperature means that diffusion rates are high and because adsorbent capacities are low, there is little to prevent the movement of components around the bed. Keeping the activated alumina in contact with water and high temperature for an extended period of time may also contribute to hydrothermal ageing of the adsorbent.

Holding the first primary adsorber bed 15-1 during regeneration may allow the thermal energy to dissipate through heat loss from the vessel 14-1 walls. Then when the regeneration is restarted, the cold regeneration gas may be unable to achieve the desired removal of the carbon dioxide (CO2) and water (H2O), greatly shortening the possible feed time when the vessel 14-1 is put back on feed.

Since the regeneration gas for the primary treatment unit 2 comes from an independent secondary treatment unit 3, the regeneration step does not have to be halted when the primary compressor 52 is shutdown. Therefore, it is possible to run the regeneration step continuously even when the main process is shutdown. It is possible to complete the regeneration of one of the first and second adsorber beds 15-1, 15-2 well before the other one of the first and second adsorber beds 15-1, 15-2 on feed has completed the feed process. The regenerated bed should, preferably, be re-pressurized as soon as practicable. The re-pressurized bed is available for operation, thereby facilitating swapping between the first and second adsorber beds 15-1, 15-2, for example when diffusion of carbon dioxide (CO2) is detected. Preferably, the first and second adsorber beds 15-1, 15-2 are not swapped until the active one of the first and second primary adsorber beds 15-1, 15-2 on feed has accumulated six (6) hours of operation, or until CO2 breakthrough occurs. This way the active primary adsorber bed 15-1 is fully utilised before it needs to go through a regeneration cycle.

The regeneration gas for regenerating the first and second adsorber beds 15-1, 15-2 in the primary treatment unit 2 is supplied from the secondary treatment unit 3 which produces treated process gas which is dry and substantially free of carbon dioxide CO2. In the present embodiment, the regeneration gas for regenerating the first and second adsorber beds 15-1, 15-2 is supplied exclusively from the secondary treatment unit 3. In a variant, a portion of the regeneration gas may be supplied from an alternate source. As shown in FIG. 1, the secondary treatment unit 3 is supplied with untreated (feed) process gas from the secondary compressor 53. The secondary compressor 53 may comprise a two-stage compression packaged unit with intercooling and aftercooling using cooling water and ambient air. The secondary compressor 53 compresses ambient air to 3.5 barg at the outlet of an aftercooler 80. As the regeneration gas flow required by the primary treatment unit 2 is not continuous, the secondary compressor 53 is configured for turndown to effectively zero flow in order to conserve power. The regeneration gas flow varies not only because the primary treatment unit 2 operates intermittently, but also because the regeneration gas is only supplied intermittently, for example for 300 minutes out of every 360 minutes. The remaining time (60 minutes in this example) is spent on depressurisation and re-pressurisation of the first and second adsorber beds 15-1, 15-2 in the primary treatment unit 2.

The secondary treatment unit 3 comprises a secondary chiller 81 for receiving the untreated (feed) process gas supplied to the secondary process gas inlet 30 from the secondary compressor 53. The secondary chiller 81 may be effectively equivalent to the primary treatment unit 2 chiller 55 described above. More than one secondary chiller 81 may be provided to provide cooling of the required volume of the process gas. The plurality of secondary chillers 81 may operate in parallel. As with the primary chiller 55, the secondary chiller 81 may comprise a bypass valve (not shown) operable to pre-emptively shut down the refrigeration loop to prevent freeze out of water in the refrigeration heat exchanger. The secondary chiller 81 may have the following exemplary operating parameters:
Pressure: 3 barg
Temperature: 26.3° C.
Dew-Point: 5° C.
CO2: 470 ppm

As described herein, the secondary treatment unit 3 shares many of the characteristics of the primary treatment unit 2. The main differences between the secondary treatment unit 3 and the primary treatment unit 2 will now be described.

Although the primary treatment unit 2 requires the supply of regenerate gas for regeneration of five (5) hours, the secondary treatment unit 3 is preferably designed to be consistent with the primary treatment unit 2 with up to a six (6) hour feed time before regeneration of one of the first and second primary adsorber beds 15-1, 15-2 is required. A preferred cycle time for the secondary treatment unit 3 is as follows:
Feed: 360 minutes
Depressurisation: 15 minutes
Heating: 60 minutes
Cooling: 270 minutes
Re-pressurisation: 15 minutes

The above operating times are provided by way of example only. It will be understood that different operating times may be applied in respect of one or more of the operating processes.

The depressurisation and re-pressurisation times are shorter than for the primary treatment unit 2 as the pressure changes within the secondary treatment unit 3 may be lower, preferably only between three (3) barg and atmospheric pressure. The heating time is longer for the secondary treatment unit 3 because of the greater amount of water in the incoming gas at this feed pressure even though the dew-points are the same.

The secondary treatment unit 3 is periodically regenerated. In particular, the first and second secondary adsorbers 32, 33 are periodically regenerated. The regeneration of the secondary treatment unit 3 may be performed independently of the operation of the primary treatment unit 2. For example, the secondary treatment unit 3 may be regenerated while the primary treatment unit 2 is online (i.e. operating) or offline (not operating). One or both of the first and second secondary adsorber beds 35-1, 35-2 of the secondary treatment unit 3 may be regenerated before the primary treatment unit 2 is brought online or after it has gone offline, i.e., before or after the primary treatment unit 2 is configured to treat the (untreated) process gas supplied from the primary gas inlet 10. Alternatively, or in addition, the regeneration of the secondary treatment unit 3 may be performed in parallel with the operation of the primary treatment unit 2. One or both of the first and second secondary adsorber beds 35-1, 35-2 of the secondary treatment unit 3 may be regenerated while the primary treatment unit 2 is online, i.e., while one of the first and second primary adsorber beds 15-1, 15-2 of the primary treatment unit 2 is operative to treat the (untreated) process gas supplied from the primary gas inlet 10. The first secondary adsorber bed 35-1 and/or the second secondary adsorber beds 35-2 of the secondary treatment unit 3 may be regenerated when the primary treatment unit 2 is operating in the first operating mode and/or the second operating mode described herein. As described herein, one of the first and second secondary adsorbers 32, 33 can be regenerated while the other one of the first and second secondary adsorbers 32, 33 operates to treat the untreated (feed) process gas supplied from the secondary process gas inlet 30. At least in certain embodiments, this enables the supply of the treated process gas from the secondary treatment unit 3 to continue while one of the first and second primary adsorber beds 15-1, 15-2 is regenerated.

The regeneration of the secondary treatment unit 3 may be performed in dependence on the operating mode of the primary treatment unit 2. A first one of the first and second secondary adsorber beds 35-1, 35-2 may be regenerated when the primary treatment unit 2 is operating in the first operating mode; and a second one of the first and second secondary adsorber beds 35-1, 35-2 may be regenerated when the primary treatment unit 2 is operating in the second operating mode. Alternatively, the regeneration of the secondary treatment unit 3 may be performed independently of the operating mode of the primary treatment unit 2. The first and second secondary adsorber beds 35-1, 35-2 may be regenerated irrespective of whether the primary treatment unit 2 is operating in the first operating mode or the second operating mode. The secondary treatment unit 3 may thereby operate independently of the primary treatment unit 2. At least in certain embodiments, this provides greater flexibility for controlling the operation of the gas treatment apparatus 1.

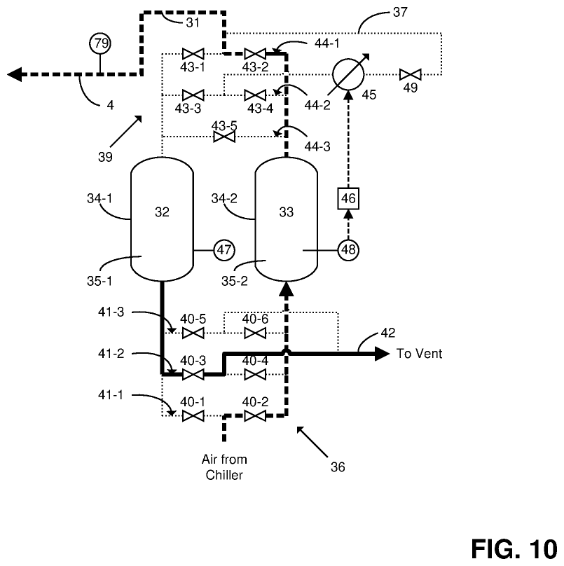

Regeneration of the secondary treatment unit 3 uses part of the treated process gas from one of the first and second secondary adsorber beds 35-1, 35-2 on feed, as per the primary treatment unit 2. Preferably, regeneration is not stopped once it has begun, even if flow to the primary treatment unit 2 is not required for regeneration. This requires feeding treated process gas through one of the first and second secondary adsorber beds 35-1, 35-2, but only that sufficient to provide regeneration gas for the secondary treatment unit 3. A variable speed compressor may be provided in the secondary compressor 53. The variable speed compressor may be controlled to vary the flow rate of the untreated (feed) process gas, for example depending on whether regeneration is being performed in respect of the secondary treatment unit 3 and/or the primary treatment unit 2. The regenerated secondary adsorber vessel 34-1, 34-2 is re-pressurized after cooling. The first secondary adsorber vessel 34-1 and/or the second secondary adsorber vessels 34-2 may be at least partially re-pressurized by supplying a portion of the regeneration gas from the other one of the first and second secondary adsorber vessels 34-1, 34-2. Alternatively, or in addition, the treated process gas from the primary treatment unit 2 could be supplied to re-pressurize the first secondary adsorber vessel 34-1 and/or the second secondary adsorber vessel 34-2. Alternatively, or in addition, the secondary compressor 53 may supply untreated (feed) process gas to re-pressurize the first secondary adsorber vessel 34-1 and/or the second secondary adsorber vessel 34-2. This enables regeneration of one of the first and second primary adsorber beds 15-1, 15-2 in the primary treatment unit 2. The operation of the secondary treatment unit 3 to regenerate the first and second primary adsorber beds 15-1, 15-2 will now be described with reference to FIGS. 10 to 15.

As illustrated in FIG. 10, the second secondary adsorber 33 performs a feed step to treat the untreated (feed) process gas supplied from the secondary process gas inlet 30. The flow of the process gas during this step is illustrated in FIG. 10 by the interrupted thick line. The gas treatment apparatus 1 is configured to control the secondary inlet control valves 40-n and the secondary outlet control valves 43-n to control the flow of the process gas. In the arrangement illustrated in FIG. 10, the second secondary inlet control valve 40-2 and the second secondary outlet control valve 43-2 are opened; and the fourth and sixth secondary inlet control valves 40-4, 40-6 and the fourth secondary outlet control valve 43-4 are closed. The secondary inlet valve system 36 is configured to supply the untreated (feed) process gas from the secondary process gas inlet 30 to the second secondary adsorber 33. In use, the untreated (feed) process gas is supplied from the secondary process gas inlet 30 and passes through the second secondary adsorber bed 35-2 to remove water (H2O) and carbon dioxide (CO2). The treated process gas is discharged from the second secondary adsorber 33 to the secondary process gas outlet 31. The second secondary adsorber 33 is placed in fluid communication with the secondary process gas outlet 31. Different configurations of the secondary inlet control valves 40-n are contemplated. For example, the fifth and sixth secondary inlet control valves 40-5, 40-6 could be omitted. The third and fourth secondary inlet control valves 40-3, 40-4 could be configured to depressurise the first and second secondary adsorbers 32, 33.

The secondary inlet control valves 40-n each have a valve flow coefficient (Cv) representing a flow capacity at fully open operating conditions relative to the pressure drop across the valve. In the present embodiment, the secondary inlet control valves 40-n have different valve flow coefficients (Cv). The secondary inlet control valves 40-n can be configured to implement different flow capacities for different operating processes. In the present embodiment, the valve flow coefficient (Cv) of the third and fourth secondary inlet control valves 40-3, 40-4 is smaller than the valve flow coefficient (Cv) of the fifth and sixth secondary inlet control valves 40-5, 40-6. As described herein, the third and fourth secondary inlet control valves 40-3, 40-4 are opened to depressurise the first and second secondary adsorber vessels, 34-1, 34-2, respectively; and the fifth and sixth secondary inlet control valves 40-5, 40-6 are opened to purge (regenerate) the first and second secondary adsorber beds 35-1, 35-2, respectively. The smaller valve flow coefficient (Cv) of the third and fourth secondary inlet control valves 40-3, 40-4 maintains a low gas flow rate for depressurisation. This may help to avoid a high gas flow rate which could result in a large downwards force on the first and second secondary adsorbent bed 35-1, 35-2), potentially causing damage to a support grid for supporting the adsorbent beds 35-1, 35-2. The first and second secondary adsorbent beds 35-1, 35-2 are preferably close to atmospheric pressure before initiating the regeneration. Otherwise, opening the purge (regeneration) step valves can result in a very large temporary gas flow due to increased gas flow.

Alternatively, one or more of the secondary inlet control valves 40-n may comprise a variable control valve. The third and fourth secondary inlet control valves 40-3, 40-4 may each comprise a variable flow control valve operable to modulate or adjust the flow capability. The third and fourth secondary inlet control valves 40-3, 40-4 may be configured to provide a first flow capability for depressurisation; and to provide a second flow capability for purge (regeneration). The first flow capability may be less than the second flow capability. Alternatively, or in addition, the third and fourth secondary inlet control valves 40-3, 40-4 may be pulsed open and closed (pulse width modulation) to modulate the flow capability. The fifth and sixth secondary inlet control valves 40-5, 40-6 may optionally be omitted.

While the second secondary adsorber bed 35-2 is active to treat the process gas, the first secondary adsorber 32 may be de-pressurized in a depressurisation step, preferably to atmospheric pressure. The flow of the process gas during this step is illustrated in FIG. 10 by the solid thick line. The first, fourth, fifth and sixth secondary inlet control valves 40-1, 40-4, 40-5, 40-6 are closed; and the fifth secondary inlet control valve 40-5 is opened to place the first secondary adsorber 32 in fluid communication with the secondary vent 42.

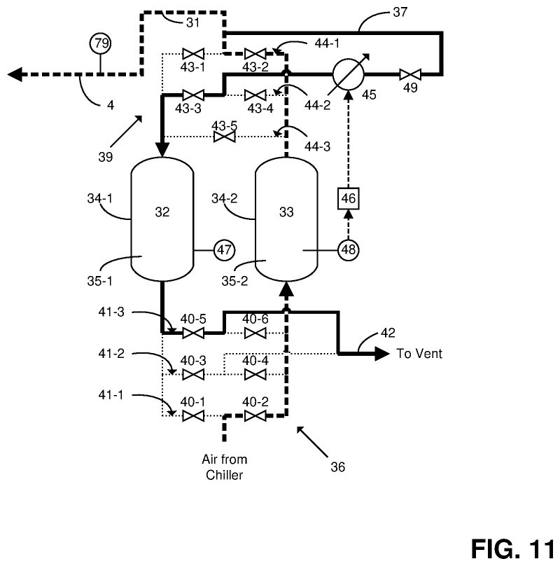

As illustrated in FIG. 11, the second secondary adsorber 33 then performs a regeneration step in which a portion of the treated process gas from the second secondary adsorber 33 is supplied to the first secondary adsorber 32 to regenerate the first secondary adsorber bed 35-1, as illustrated by the solid thick line in FIG. 11. The first and fourth secondary outlet control valves 43-1, 43-4 are closed; and the third secondary outlet control valve 43-4 is opened to connect the first secondary adsorber 32 to the secondary process gas outlet 31. The fifth secondary outlet control valve 43-5 is closed. The first, third, fourth and sixth secondary inlet control valves 40-1, 40-3, 40-4, 40-6 are closed; and the third secondary inlet control valve 40-3 is opened to place the first secondary adsorber 32 in fluid communication with the secondary vent 42. A portion of the treated process gas from the second secondary adsorber 33 is supplied to the first secondary adsorber 32 via the heater supply conduit 37. The secondary regeneration control valve 49 may be controlled to control the supply of the treated process gas to perform regeneration. The secondary regeneration heater 45 is controllable to adjust heating of the treated process gas prior to introduction into the first secondary adsorber 32 to regenerate the first secondary adsorber bed 35-1. The second heater controller 46 may, for example, control the secondary regeneration heater 45 in dependence on the second operating temperature T2 measured by the second secondary temperature sensor 48. The de-pressurization of the first secondary adsorber 32 and the supply of the treated process gas to regenerate the first secondary adsorber 32 are described as being performed as separate steps. It will be understood that the de-pressurization and regeneration may be performed concurrently. For example, the first secondary adsorber 32 may be placed in fluid communication with the secondary vent 42 at substantially the same time as, or after initiating the supply of the regeneration gas. This control strategy may be employed during regeneration of the other adsorbers described herein, for example during regeneration of the first and second primary adsorbers 12, 13.

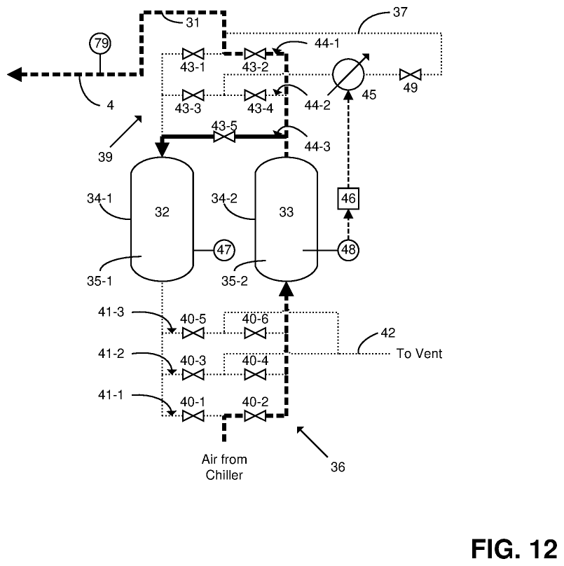

After regeneration of the first adsorber bed 35-1, the first secondary adsorber vessel 34-1 is re-pressurized. The first secondary adsorber vessel 34-1 could be re-pressurized by closing the first, third and fifth secondary inlet control valves 40-1, 40-3, 40-5 while continuing to supply treated process gas via the heater supply conduit 37. In the present embodiment, as illustrated in FIG. 12, the fifth secondary outlet control valve 43-5 is used to control the supply of the treated process gas from the second secondary adsorber 33 to re-pressurize the first secondary adsorber vessel 34-1. The gas treatment apparatus 1 is configured to control the secondary inlet control valves 40-n and the secondary outlet control valves 43-n to re-pressurize the first secondary adsorber vessel 34-1. The second secondary inlet control valve 40-2 and the second secondary outlet control valve 43-2 are opened. The first, third, fourth, fifth and sixth secondary inlet control valves 40-1, 40-3, 40-4, 40-5, 40-6 and the first, third and fourth secondary outlet control valves 43-1, 43-3, 43-4 are closed. The fifth secondary outlet control valves 43-5 is opened to supply a portion of the treated process gas from the second secondary adsorber 33 to the first secondary adsorber 32, as illustrated by the solid thick line in FIG. 12. The fifth secondary outlet control valve 43-5 may be selectively opened to supply treated process gas to the first secondary adsorber 32 to re-pressurise the first secondary adsorber 32. The re-pressurisation of the first secondary adsorber vessel 34-2 may, for example, be performed over a period of approximately thirty (30) minutes. The re-pressurisation in the present embodiment comprises supplying a portion of the treated process gas discharged from the second secondary adsorber 32 to the first secondary adsorber 33.

The fifth secondary outlet control valve 43-5 may be a variable flow control valve or a proportional control valve to control the supply of treated process gas. Alternatively, a flow restrictor may be provided to control the supply of the treated process gas. In the present embodiment, the first secondary adsorber vessel 34-1 is re-pressurized from the top with flow in the downwards direction. In a variant, the re-pressurisation may be performed from the bottom with flow in the upwards direction.

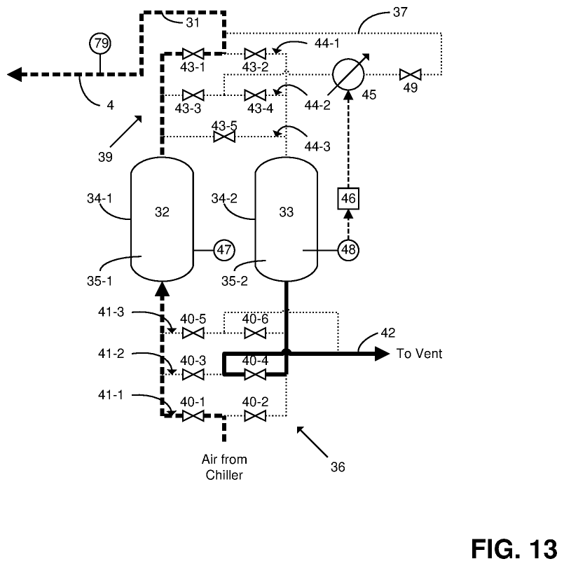

As illustrated in FIG. 13, the first secondary adsorber 32 performs a feed step to treat the process gas in which the untreated (feed) process gas is supplied to the first secondary adsorber bed 35-1. The flow of the process gas during this step is illustrated in FIG. 13 by the interrupted thick line. The gas treatment apparatus 1 is configured to control the secondary inlet control valves 40-n and the secondary outlet control valves 43-n to control the flow of the process gas. In the arrangement illustrated in FIG. 13, the first secondary inlet control valve 40-1 and the first secondary outlet control valve 43-1 are opened; and the third and fifth secondary inlet control valves 40-3, 40-5 and the third secondary outlet control valve 43-3 are closed. The secondary process gas inlet 30 is configured to supply the untreated (feed) process gas to the first secondary adsorber 32. In use, the untreated (feed) process gas is supplied from the secondary process gas inlet 30 and is treated by the first secondary adsorber bed 35-1 to remove water (H2O) and carbon dioxide (CO2). The treated process gas is discharged from the first secondary adsorber 32 to the secondary process gas outlet 31.

While the first secondary adsorber bed 35-1 is active to treat the process gas, the second secondary adsorber 33 may be de-pressurized in a depressurisation step, preferably to atmospheric pressure. The flow of the process gas during this step is illustrated in FIG. 13 by the solid thick line. The second, third, fifth and sixth secondary inlet control valves 40-2, 40-3, 40-5, 40-6 are closed; and the sixth secondary inlet control valve 40-6 is opened to place the second secondary adsorber 33 in fluid communication with the secondary vent 42, as illustrated by the solid thick line in FIG. 13.

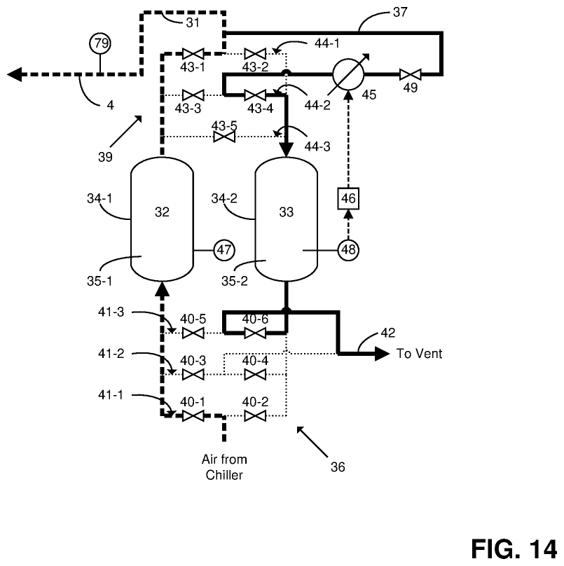

As illustrated in FIG. 14, the second secondary adsorber 33 then performs a regeneration step in which a portion of the treated process gas from the first secondary adsorber 32 is supplied to the second secondary adsorber 33 to regenerate the second secondary adsorber bed 35-2, as illustrated by the solid thick line in FIG. 14. The second and third secondary outlet control valves 43-2, 43-3 are closed; and the fourth secondary outlet control valve 43-4 is opened to connect the second secondary adsorber 33 to the secondary process gas outlet 31. The fifth secondary outlet control valve 43-5 is closed. The second, third, fourth and fifth secondary inlet control valves 40-2, 40-3, 40-4, 40-5 are closed; and the fourth secondary inlet control valve 40-4 is opened to place the second secondary adsorber 33 in fluid communication with the secondary vent 42. A portion of the treated process gas from the first secondary adsorber 32 is supplied to the second secondary adsorber 33 via the heater supply conduit 37. The secondary regeneration control valve 49 may be controlled to control the supply of the treated process gas to perform regeneration. The secondary regeneration heater 45 is controllable to adjust heating of the treated process gas prior to introduction into the second secondary adsorber 33 to regenerate the second secondary adsorber bed 35-2. The second heater controller 46 may, for example, control the secondary regeneration heater 45 in dependence on the first operating temperature T1 measured by the first secondary temperature sensor 47. The de-pressurization of the second secondary adsorber 33 and the supply of the treated process gas to regenerate the second secondary adsorber 33 are described as being performed as separate steps. It will be understood that the de-pressurization and regeneration may be performed concurrently. For example, the second secondary adsorber 33 may be placed in fluid communication with the secondary vent 42 at substantially the same time as, or after initiating the supply of the regeneration gas. This control strategy may be employed during regeneration of the other adsorbers described herein, for example during regeneration of the first and second primary adsorbers 12, 13.

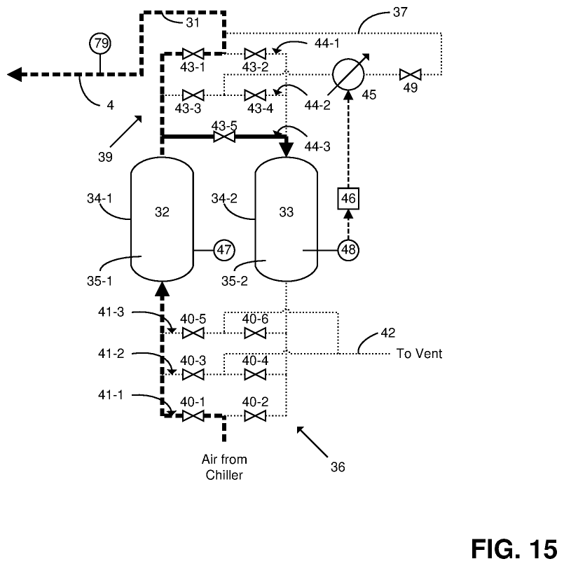

After regeneration of the second adsorber bed 35-1, the second secondary adsorber vessel 34-2 is re-pressurized. The second secondary adsorber vessel 34-2 could be re-pressurized by closing the second, fourth and sixth secondary inlet control valves 40-2, 40-4, 40-6 while continuing to supply treated process gas via the heater supply conduit 37. In the present embodiment, as illustrated in FIG. 15, the fifth secondary outlet control valve 43-5 is used to control the supply of the treated process gas from the first secondary adsorber 32 to re-pressurize the second secondary adsorber vessel 34-2. The gas treatment apparatus 1 is configured to control the secondary inlet control valves 40-n and the secondary outlet control valves 43-n to re-pressurize the second secondary adsorber vessel 34-2. The first secondary inlet control valve 40-1 and the first secondary outlet control valve 43-1 are opened. The second, third, fourth, fifth and sixth secondary inlet control valves 40-2, 40-3, 40-4, 40-5, 40-6 and the second, third and fourth secondary outlet control valves 43-2, 43-3, 43-4 are closed. The fifth secondary outlet control valves 43-5 is opened to supply a portion of the treated process gas from the first secondary adsorber 32 to the second secondary adsorber 33, as illustrated by the solid thick line in FIG. 15. The fifth secondary outlet control valve 43-5 may be selectively opened to supply treated process gas to the second secondary adsorber 33. The re-pressurisation of the second secondary adsorber vessel 34-2 may, for example, be performed over a period of approximately thirty (30) minutes. The re-pressurisation in the present embodiment comprises supplying a portion of the treated process gas discharged from the first secondary adsorber 32 to the second secondary adsorber 33. The fifth secondary outlet control valve 43-5 may be a variable flow control valve or a proportional control valve to control the supply of treated process gas. Alternatively, a flow restrictor may be provided to control the supply of the treated process gas. In the present embodiment, the first secondary adsorber vessel 34-1 is re-pressurized from the top with flow in the downwards direction. In a variant, the re-pressurisation may be performed from the bottom with flow in the upwards direction.

As shown in FIGS. 10 and 12, the regeneration of the first and second secondary adsorber beds 35-1, 35-2 in the present embodiment is carried out in a downflow direction. The water (H2O) can be condensed out by cooling on the outlet vessel head. By regenerating in the downflow direction, this condensed water is pushed out towards the secondary process gas vent 22.

In terms of carbon dioxide CO2 removal, the design of the secondary treatment unit 3 is consistent with the primary treatment unit 2 in sizing the adsorbents for a preferred 1 ppm peak breakthrough and less than 100 ppb time-average. Alternatively, the primary treatment unit 2 can be stated as requiring the carbon dioxide (CO2) partial pressure at the outlet to be no more than 1.6 Pa maximum and less than 0.16 Pa on average. This means that the amount of CO2 in the regeneration gas must also be less than these numbers on a partial pressure basis. This equates to CO2 partial pressures exit the secondary treatment unit 3 before the pressure is dropped to near atmospheric of about 5 Pa maximum and 0.5 Pa on average. At an operating pressure of 3 barg, this equates to 12 ppm maximum allowable breakthrough and 1.2 ppm time average, i.e. a breakthrough allowance that is more than an order of magnitude greater than the secondary treatment unit 3 is designed for.

Prior to start-up for the first time, the primary and secondary adsorber vessels 14-1, 14-2, 34-1, 34-2 are filled with the required quantities of adsorbent. As water from the ambient air can adsorb onto the materials and liquid water damage their structure, this should be done in dry conditions.

The secondary treatment unit 3 is started before the primary treatment unit 2. The secondary compressor 53 and the secondary chiller 81 are turned on to bring the supply of the process gas up to an operating pressure and to reduce the temperature of the refrigerant in the secondary chiller 81. Compressed process gas is then bypassed around the feed inlet valve of a selected one of the first and second secondary adsorber beds 35-1, 35-2 to slowly bring it up to pressure. Once this has been achieved, the inlet feed valve is opened. The treated process gas from the selected one of the first and second secondary adsorber beds 35-1, 35-2 is then used to regenerate the other one of the first and second secondary adsorber beds 35-1, 35-2. An extended heating time of 6 hours is recommended, followed by a cooling step. The regenerated secondary adsorber beds 35-1, 35-2 is then re-pressurized, swapped onto feed and the other one of the first and second secondary adsorber beds 35-1, 35-2 is regenerated. Again, the recommendation is that the heating time should be 6 hours with subsequent cooling. This process should be repeated in swapping beds over until the gas coming from the product end of both the first and second secondary adsorber beds 35-1, 35-2 is suitably dry and carbon dioxide (CO2) free. This may take one or more cycles to achieve since the regeneration air from the first bed may contain water and carbon dioxide (CO2) which should be expelled from the system.

The extended heating time is required to make sure the adsorbent is as dry as possible given that it can come from the vendor with up to 1.5 percentage by weight (wt %) water and can also pick up water from the atmosphere during loading.

With the secondary treatment unit 3 put into normal regeneration mode, the treated process gas from the secondary treatment unit 3 can now be supplied as a regeneration gas for regenerating both the first and second primary adsorber beds 15-1, 15-2 in the primary treatment unit 2. This is again carried out with a 6-hour heating step followed by cooling of both the first and second primary adsorber beds 15-1, 15-2. As the gas sent to regenerate the first and second primary adsorber beds 15-1, 15-2 is clean, a single regeneration should be sufficient.

The primary compressor 52 is now started along with the primary chiller 55. The process gas is bypassed around one of the feed inlet valves to one of the first and second primary adsorber beds 15-1, 15-2 and re-pressurized. Treated process gas can then be taken from the first adsorber vessel 14-1 and checks on the dryness and carbon dioxide (CO2) content be made. If this is too high, then the first primary adsorber bed 15-1 can be de-pressurized and regenerated again using the regeneration gas supplied from the secondary treatment unit 3. This can be repeated until the required carbon dioxide (CO2) and water (H2O) requirements are met. Once this has been done for one of the first and second primary adsorber beds 15-1, 15-2, the process can be repeated for the other one of the first and second primary adsorber beds 15-1, 15-2.

It will be appreciated that various changes and modifications can be made to the present invention without departing from the scope of the present application.

1. A gas treatment apparatus for treating a process gas, the gas treatment apparatus comprising a primary treatment unit and a secondary treatment unit, the primary and secondary treatment units being configured to treat the process gas, wherein:
the primary treatment unit comprises a primary process gas inlet for receiving the process gas, a first and a second primary adsorber for treating the process gas, and at least one primary process gas outlet for discharging the treated process gas from the first and the second primary adsorbers;
the secondary treatment unit comprising a secondary process gas inlet for receiving the process gas, at least one secondary adsorber for treating the process gas, and at least one secondary process gas outlet for discharging the treated process gas from the at least one secondary adsorber to the primary treatment unit;
the primary treatment unit being selectively configurable in a first operating mode and a second operating mode;
when operating in the first operating mode, the primary process gas inlet is connected to the first primary adsorber to supply the process gas to the first primary adsorber for treatment; and the second primary adsorber is connected to the at least one secondary process gas outlet to receive treated process gas from the secondary treatment unit for regenerating the second primary adsorber; and
when operating in the second operating mode, the primary process gas inlet is connected to the second primary adsorber to supply the process gas to the second primary adsorber for treatment; and the first primary adsorber is connected to the at least one secondary process gas outlet to receive treated process gas from the secondary treatment unit for regenerating the first primary adsorber.

2. The gas treatment apparatus as claimed in claim 1, wherein when operating in the first operating mode, after regeneration of the second primary adsorber, a portion of the treated process gas from the first primary adsorber is supplied to re-pressurise the second primary adsorber.

3. The gas treatment apparatus as claimed in claim 1, wherein when operating in the second operating mode, after regeneration of the first primary adsorber, a portion of the treated process gas from the second primary adsorber is supplied to re-pressurise the first primary adsorber.

4. The gas treatment apparatus as claimed in claim 1, wherein when operating in the first operating mode, prior to regeneration of the second primary adsorber, the second primary adsorber is de-pressurized.

5. The gas treatment apparatus as claimed in claim 1, wherein when operating in the second operating mode, prior to regeneration of the first primary adsorber, the first primary adsorber is de-pressurized.

6. The gas treatment apparatus as claimed in claim 1, further comprising a primary regeneration heater for heating the treated process gas from the secondary treatment unit prior to introduction into the primary treatment unit.

7. The gas treatment apparatus as claimed in claim 1, wherein the gas treatment apparatus is selectively configurable to regenerate the secondary treatment unit, the regeneration of the secondary treatment unit being performed independently of the operating mode of the primary treatment unit.

8. The gas treatment apparatus as claimed in claim 1, wherein the at least one secondary adsorber comprises first and second secondary adsorbers for treating the process gas.

9. The gas treatment apparatus as claimed in claim 8, wherein, in use, one of the first and second secondary adsorbers is operatively selected to treat the process gas, and the other one of the first and second secondary adsorbers is regenerated.

10. The gas treatment apparatus as claimed in claim 9, wherein regeneration comprises outputting a portion of the treated process gas from the selected one of the first and second secondary adsorbers to regenerate the other one of the first and second secondary adsorbers.

11. The gas treatment apparatus as claimed in claim 10, further comprising a secondary regeneration heater for heating the treated process gas for regenerating the other one of the first and second secondary adsorbers.

12. The gas treatment apparatus as claimed in claim 1, further comprising:
a primary compressor for compressing the process gas supplied to the primary process gas inlet of the primary treatment unit; and/or
a secondary compressor for compressing the process gas supplied to the secondary process gas inlet of the secondary treatment unit.

13. The gas treatment apparatus as claimed in claim 1, further comprising:
a primary outlet valve system configured selectively to connect one of the first and second primary adsorbers to the at least one primary process gas outlet;
wherein the primary outlet valve system is configured selectively to connect the secondary treatment unit to one of the first and second primary adsorbers to perform regeneration.

14. The gas treatment apparatus as claimed in claim 1, further comprising a secondary outlet valve system configured selectively to connect one of the first and second secondary adsorbers to the at least one secondary process gas outlet.

15. The gas treatment apparatus as claimed in claim 1, further comprising a primary inlet valve system configured selectively to connect the primary process gas inlet to one of the first and second primary adsorbers;
wherein the primary inlet valve system is configured selectively to vent process gas from one of the first and second primary adsorbers for depressurising said first and second primary adsorber.

16. The gas treatment apparatus as claimed in claim 1, further comprising a secondary inlet valve system configured selectively to connect the secondary process gas inlet to one of the first and second secondary adsorbers;
wherein the secondary inlet valve system is configured selectively to vent process gas from one of the first and second secondary adsorbers for depressurising said first and second primary adsorber.

17-18. (canceled)

19. A method of controlling a gas treatment apparatus to treat a process gas, the gas treatment apparatus comprising:
a primary treatment unit comprising a primary process gas inlet for receiving the process gas, a first and a second primary adsorber for treating the process gas, and at least one primary process gas outlet for discharging the treated process gas from the first and the second primary adsorbers; and
a secondary treatment unit comprising a secondary process gas inlet for receiving the process gas, at least one secondary adsorber for treating the process gas, and at least one secondary process gas outlet for discharging the treated process gas from the at least one secondary adsorber to the primary treatment unit;
wherein the method comprises selectively operating the primary treatment unit in a first operating mode and a second operating mode;
when operating in the first operating mode, the primary process gas inlet is connected to the first primary adsorber to supply the untreated process gas to the first primary adsorber for treatment; and the second primary adsorber is connected to the at least one secondary process gas outlet to receive treated process gas from the secondary treatment unit for regenerating the second primary adsorber; and
when operating in the second operating mode, the primary process gas inlet is connected to the second primary adsorber to supply the process gas to the second primary adsorber for treatment; and the first primary adsorber is connected to the at least one secondary process gas outlet to receive treated process gas from the secondary treatment unit for regenerating the first primary adsorber.

20. (canceled)

21. A method of controlling a gas treatment apparatus to treat a process gas, the gas treatment apparatus comprising:
a primary treatment unit comprising a primary process gas inlet for receiving the process gas, a first and a second primary adsorber for treating the process gas, and at least one primary process gas outlet for discharging the treated process gas from the first and the second primary adsorbers; and
a secondary treatment unit comprising a secondary process gas inlet for receiving the process gas, at least one secondary adsorber for treating the process gas, and at least one secondary process gas outlet for discharging the treated process gas from the at least one secondary adsorber to the primary treatment unit;
wherein the method comprises:
connecting the primary process gas inlet to the first primary adsorber to supply the untreated process gas to the first primary adsorber for treatment in a first operating mode;
connecting the primary process gas inlet to the second primary adsorber to supply the process gas to the second primary adsorber for treatment in a second operating mode; and
connecting the secondary treatment unit to at least one of the first and the second primary adsorbers to supply treated process gas to regenerate the at least one of the first and the second primary adsorbers.

22. An electronic control unit configured to control a gas treatment apparatus to perform the method claimed in claim 19.

23. A liquid air energy storage plant comprising a gas treatment apparatus as claimed in claim 1.
